(19) United States
(12) Patent Application Publication
(10) Pub. No.: US 2026/0231215 A1
(43) Pub. Date: Aug. 6, 2026

(54) CONFIGURED GRANT ENHANCEMENT FOR EXTENDED REALITY AND CLOUD GAMING SERVICES

(71) Applicant: GOOGLE LLC, Mountain View, CA (US)

(72) Inventors: Abdellatif Salah, Mountain View, CA (US); Chih-Hsiang Wu, Taoyuan City (TW)

(21) Appl. No.: 19/154,995

(22) PCT Filed: Feb. 9, 2024
(86) PCT No.: PCT/US2024/015103

§ 371 Date: Aug. 8, 2025

Related U.S. Application Data
(60) Provisional application No. 63/484,434, filed on Feb. 10, 2023.

(51) Int. Cl. H04W 74/0816; H04L 1/1812; H04W 74/00

(52) U.S. Cl. CPC H04W 74/0816; H04L 1/1812; H04W 74/006

(57) ABSTRACT

A user equipment (UE) can implement a method for managing request process identifiers. The method includes: transmitting, from the UE to a radio access network (RAN) node, an uplink transmission using one or more configured grant (CG) resources; receiving, at the UE, downlink control information including a request process identifier based on a number of CG uplink channel occasions in a CG period such that the request process identifier is determined using the number of CG uplink channel occasions in the CG period multiplied by an output of a floor function, the floor function calculated using a symbol index for a respective CG uplink channel occasion and a periodicity of the CG period; and retransmitting, from the UE, a transmission of the uplink transmission based on the request process identifier.

### CROSS-REFERENCE TO RELATED APPLICATIONS

This application claims priority to and the benefit of the filing date of provisional U.S. Patent Application No. 63/484,434 entitled “CONFIGURED GRANT ENHANCEMENT FOR EXTENDED REALITY AND CLOUD GAMING SERVICES,” filed on Feb. 10, 2023. The entire contents of the provisional applications are hereby expressly incorporated herein by reference.

### FIELD OF THE DISCLOSURE

This disclosure relates to wireless communications and, more particularly, to managing communication using enhanced UL scheduling mechanisms for real time media services with high data rate and low latency, such as eXtended Reality services (XR) and cloud gaming (CG) services. The disclosure proposes enhancement to the configured grant (CG) scheduling mechanisms to better support UL XR traffic.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A number of real time media services have high data rates and benefit from low latency, such as eXtended Reality (XR) media, which can in turn include any or all of Augmented Reality (AR), Virtual Reality (VR), and Mixed Reality (MR) media. In virtual reality, the user is fully immersed in a virtual environment that functions as a substitute for the real environment by wearing a head-mounted device. Augmented reality augments the perception of the real environment with some virtual elements, so some virtual elements are overlaid on the perception of the real environment. Mixed reality is an extension of AR, in which the real and virtual elements can interact in real time. Similarly, cloud gaming runs video games on remote servers without the need for a gaming console or a high spec CPU and GPU to play the games. Cloud gaming streams a game like streaming a video, and the game will respond to the gamer commands and controls in real time, and therefore often has high data rate while benefiting from low latency.

Wireless XR and wireless Cloud gaming offer better freedom of movement as wireless eliminates the geographical or behavioural restrictions and allows XR users to move freely. Wireless XR also enables new applications like remote education in immersive environment for remote areas not connected with good DSL or Fiber. Multiple XR scenarios and applications are deployed. Offline sharing of 3D objects consists of sharing 3D models or objects and 3D mixed reality scenes amongst users (e.g., using a phone equipped with a depth camera to capture an image in 3D and then share it with a contact). XR conferencing is another use case and consists of users interacting in virtual environment and sharing a 3D experience with each other. In further scenarios, XR conferencing includes presentation of some content and discussions with other users in the same conference.

The XR traffic is a quasi-periodic traffic with the period equal to the inverse of the XR frame rate. Hence, if the frame rate is 60 frames per second (fps), the periodicity is 16.67 milliseconds (ms). The XR traffic suffers from jitter due to the delay variations at the codec to encode the video frames. The jitter can be statistically modelled as a truncated Gaussian distribution with 2 ms standard deviation and +/−4 ms range. The XR packet sizes are also large and variable due to the variability in the video frame content. Similarly, the XR packet sizes can also be statistically modelled as a truncated Gaussian distribution.

Enhancements to Configured Grant scheduling are needed to enable the support of the UL XR service on 5G with good system capacity.

### SUMMARY

The embodiments described herein discuss enhancement to uplink (UL) XR scheduling to support XR traffic and the associated latency and reliability requirements. XR traffic consists of large packets with variable sizes arriving quasi-periodically. New scheduling techniques and enhancements of the existing techniques are needed for the scheduling of the XR packets (e.g., uplink Augmented Reality traffic). As such, the embodiments herein improve the system capacity and support more users consuming the service simultaneously. The enhancements further address the latency and reliability limitations of the existing schemes.

An example embodiment of the techniques of this disclosure is a method, implemented in a user equipment (UE), for managing request process identifiers, the method comprising: transmitting, from the UE to a radio access network (RAN) node, an uplink transmission using one or more configured grant (CG) resources; receiving, at the UE, downlink control information including a request process identifier based on a number of CG uplink channel occasions in a CG period such that the request process identifier is determined using the number of CG uplink channel occasions in the CG period multiplied by an output of a floor function, the floor function calculated using a symbol index for a respective CG uplink channel occasion and a periodicity of the CG period; and retransmitting, from the UE, a transmission of the uplink transmission based on the request process identifier.

Another example embodiment of these techniques is a user equipment (UE) comprising processing hardware and configured to implement the method above.

Another example embodiment of these techniques is a method implemented in a radio access network (RAN) node, the method comprising: communicating, at the RAN node, with a user equipment (UE) using one or more configured grant (CG) resources; determining, at the RAN node, a request process identifier based on a number of CG uplink channel occasions in a CG period such that the request process identifier is determined using the number of CG uplink channel occasions in the CG period multiplied by an output of a floor function, the floor function calculated using a symbol index for a respective CG uplink channel occasion and a periodicity of the CG period; and transmitting, to the UE, a request for retransmission of a failed transmission, the request including the request process identifier.

Another example embodiment of these techniques is a radio access network (RAN) node comprising processing hardware and configured to implement the method above.

### BRIEF DESCRIPTION OF THE DRAWINGS

FIG. 1A is a block diagram of an example system in which a distributed base station and/or a user equipment (UE) can implement the techniques of this disclosure for managing a radio connection of the UE during early data transmission (EDT);

FIG. 1B is a block diagram of an example base station including a central unit (CU) and a distributed unit (DU) of a distributed base station that can operate in the system of FIG. 1A;

FIG. 2 is a block diagram of an example protocol stack according to which the UE of FIGS. 1A-B can communicate with base stations;

FIG. 3 is a signalling diagram that depicts the base station's configuration of the UE with a Configured Grant (CG) configuration containing multiple CG-PUSCH occasions;

FIG. 4 illustrates an example of the transmission of multiple CG-PUSCH occasions across multiple slots in the CG period;

FIG. 5 illustrates an example of the CG-PUSCH occasions being counted on UL slots in time division duplex (TDD) mode;

FIG. 6A illustrates an example case of a CG-PUSCH occasion crossing the slot boundary;

FIG. 6B illustrates an example case of a CG-PUSCH occasion crossing the slot boundary and being segmented in two segments: one segment in Slot #N and one segment in Slot #N+1;

FIG. 6C illustrates an example case of a CG-PUSCH occasion crossing the slot boundary and the CG-PUSCH occasion being shifted from Slot #N to the start of Slot #N+1;

FIG. 6D illustrates an example case of a CG-PUSCH occasion crossing the slot boundary and the CG-PUSCH occasion being rate matched to fit into the remaining symbols of Slot #N;

FIG. 6E illustrates an example case of a CG-PUSCH occasion crossing the slot boundary and the CG-PUSCH occasion being dropped and not transmitted;

FIG. 7 illustrates an example case of defining PUSCH offsets for the Configured Grant CG-PUSCH occasions for the UL XR traffic;

FIG. 8 illustrates an example case of defining a start range where the first CG-PUSCH occasion has the flexibility to start during the start range;

FIG. 9 illustrates an example of using HARQ Process ID (HPI) offsets for CG-PUSCH occasions indices in the CG period for HPI formula;

FIG. 10 illustrates an example HPI formula using the total number of CG-PUSCH occasions in the CG cycle and the index of each CG-PUSCH occasion in the CG cycle;

FIG. 11 illustrates an example of configuring PDCCH monitoring occasion after the end of all CG-PUSCH occasions in the CG period to schedule retransmission where a single DCI could be used to schedule all retransmissions;

FIG. 12 illustrates an example of the UE indicating the cancellation of some CG-PUSCH occasions and the base station re-activating the cancelled occasions for HARQ retransmissions following failed CG-PUSCH occasions transmission; and

FIG. 13 illustrates an example of using different DMRS configurations for the different CG-PUSCH occasion in the CG period.

### DETAILED DESCRIPTION

XR media services include various demanding services. Some XR media services have high data rate and reliability requirements as well as low latency requirements. The requirements provide a good user quality of experience (QoE), but also limit the system capacity, leading to high costs and/or difficulties for deployment. Scheduling enhancements allow for a larger number of UEs to consume the service simultaneously. Scheduling enhancements can include new scheduling techniques but also enhancement to the existing techniques. Enhancements, to be efficient, should take into consideration the specificities of the XR traffic (periodicities, packets sizes, jitter, . . . ) as shown herein.

As modelled (e.g., in 3GPP technical report (TR) 38.838, section 5.1), the UL AR video traffic has variable frame sizes, and the ratio between I-frame/slice and P-frame/slice is between 1.5 and 3 times. Therefore, using fixed size radio resource allocation is sub-optimal and will impact the system performance and/or the system efficiency. As the UL AR traffic is periodic and includes latency requirements, it is beneficial to use Configured Grant (CG) as the UL dynamic scheduling, which includes sending a scheduling request (SR) and then receiving an UL grant to send the buffer status report (BSR). The signalling overhead (SR, BSR, and UL DCI) consumes resources and increases the latency, hence the improvement available by using CG with some enhancements to address the variable frame sizes and reduce the signalling overhead.

Further, CG candidate techniques to improve XR capacity can focus on (i) dynamic indication of the unused CG-PUSCH occasion(s) or resource(s) by the UE and (ii) increasing CG PUSCH transmission occasions in a duration. In particular, such techniques may include (i) multiple CG PUSCH transmission occasions in a period of a single CG PUSCH configuration (RAN1, RAN2) and/or (ii) dynamic indication of unused CG-PUSCH occasion(s) based on UCI by the UE (RAN1).

Multiple CG-PUSCH occasions in the CG period are supported in the unlicensed spectrum (e.g., in Rel-16 NR-U; 3GPP technical specification (TS) 38.214, section 6.1.2.3). A set of allowed periodicities P are defined (e.g., in 3GPP TS 38.214, section 12; 3GPP TS 38.331). The higher layer parameter cg-nrofSlots provides the number of consecutive slots allocated within a configured grant period. The higher layer parameter cg-nrofPUSCH-InSlot provides the number of consecutive PUSCH allocations within a slot, where the first PUSCH allocation follows the higher layer parameter timeDomainAllocation for Type 1 PUSCH transmission or the higher layer configuration (e.g., according to 3GPP TS 38.214, section 10; 3GPP TS 38.321), and UL grant received on the DCI for Type 2 PUSCH transmissions. The remaining PUSCH allocations have the same length and PUSCH mapping type, and are appended following the previous allocations without any gaps. The same combination of start symbol and length and PUSCH mapping type repeats over the consecutively allocated slots.

In some implementations, the NR-U CG configuration enabling multiple CG-PUSCH occasions in the CG period is semi-static and does not adapt to the varying size of the XR frames. Similarly, the NR-U CG configuration is not very flexible in terms of configuration.

When the UE is configured with a CG, the UE periodically transmits a single PUSCH transmission in accordance with a CG without receiving a dynamic grant. The UE derives a HARQ Process ID (HPI) associated with each PUSCH transmission using the following formula (e.g., defined in 3GPP TS 38.321): HPI=[floor(CURRENT_symbol/periodicity)]modulo nrofHARQ-Processes, where CURRENT_symbol=(SFN×SlotsPerFrame×SymbolsPerSlot)+(SlotNumber×SymbolsPerSlot)+SymbolNumber. In such implementations, SymbolsPerSlot is 14 for normal cyclic prefix (CP) and 12 for extended cyclic prefix (ECP). The SFN is the system Frame Number. SlotNumber is the slot number within which the PUSCH starts. The SymbolNumber is the symbol number at which the PUSCH starts.

The base station 104 configures the UE 102 with the number of HARQ processes (i.e., nrofHARQ-Processes) and the periodicity in a CG configuration (e.g., a ConfiguredGrantConfig IE (e.g., defined in 3GPP TS 38.331)). In some cases, when the base station fails to receive a HARQ transmission transmitted by the UE according to the CG configuration using a HARQ process, the base station 104 dynamically schedules the UE 102 to transmit a HARQ retransmission for the HARQ transmission by transmitting a DCI to the UE. In such cases, the base station 104 signals the HARQ Process ID associated with the requested retransmission in the scheduling DCI. Thus, the UE 102 transmits a HARQ retransmission for the initial HARQ transmission to the base station 104 in accordance with the DCI using the HARQ process.

In some implementations, the base station configures multiple CG-PUSCH occasions in a CG period, and the UE transmits a PUSCH transmission on each of the CG-PUSCH occasions using a CG. However, it is not clear how to determine a HARQ process ID for each PUSCH transmission in a CG period. As shown in Table I below, the existing formula has a limitation and sometimes leads to errors when applied as is for the case of multiple CG-PUSCH occasions in a CG period, as all CG-PUSCH occasions in the same CG period will get the same HARQ Process ID (value). As a result, the UE and base station do not uniquely determine a HARQ Process ID for a particular PUSCH transmission, which causes the HARQ retransmission mechanism to not work.

TABLE I
HARQ Process ID Determination in Legacy Configured Grant

| nrofHARQ-Processes | 8 | | | | |
|---|---|---|---|---|---|
| SymbolsPerSlot | 14 | | | | |
| SlotsPerFrame | 20 | (for SCS = 30 Khz) | | | |
| Periodicity | 2 | 7 | 14 | 28 | 56 |
| current_symbol | HPI | | | | |
| 0 | 0 | 0 | 0 | 0 | 0 |
| 1 | 0 | 0 | 0 | 0 | 0 |
| 2 | 1 | 0 | 0 | 0 | 0 |
| 3 | 1 | 0 | 0 | 0 | 0 |
| 4 | 2 | 0 | 0 | 0 | 0 |
| 5 | 2 | 0 | 0 | 0 | 0 |
| 6 | 3 | 0 | 0 | 0 | 0 |
| 7 | 3 | 1 | 0 | 0 | 0 |
| 8 | 4 | 1 | 0 | 0 | 0 |
| 9 | 4 | 1 | 0 | 0 | 0 |
| 10 | 5 | 1 | 0 | 0 | 0 |
| 11 | 5 | 1 | 0 | 0 | 0 |
| 12 | 6 | 1 | 0 | 0 | 0 |
| 13 | 6 | 1 | 0 | 0 | 0 |
| 14 | 7 | 2 | 1 | 0 | 0 |
| 15 | 7 | 2 | 1 | 0 | 0 |
| 16 | 0 | 2 | 1 | 0 | 0 |
| 17 | 0 | 2 | 1 | 0 | 0 |
| 18 | 1 | 2 | 1 | 0 | 0 |
| 19 | 1 | 2 | 1 | 0 | 0 |
| 20 | 2 | 2 | 1 | 0 | 0 |
| 21 | 2 | 3 | 1 | 0 | 0 |
| 22 | 3 | 3 | 1 | 0 | 0 |
| 23 | 3 | 3 | 1 | 0 | 0 |
| 24 | 4 | 3 | 1 | 0 | 0 |
| 25 | 4 | 3 | 1 | 0 | 0 |
| 26 | 5 | 3 | 1 | 0 | 0 |
| 27 | 5 | 3 | 1 | 0 | 0 |
| 28 | 6 | 4 | 2 | 1 | 0 |
| 29 | 6 | 4 | 2 | 1 | 0 |
| 30 | 7 | 4 | 2 | 1 | 0 |
| 31 | 7 | 4 | 2 | 1 | 0 |
| 32 | 0 | 4 | 2 | 1 | 0 |
| 33 | 0 | 4 | 2 | 1 | 0 |
| 34 | 1 | 4 | 2 | 1 | 0 |
| 35 | 1 | 5 | 2 | 1 | 0 |
| 36 | 2 | 5 | 2 | 1 | 0 |
| 37 | 2 | 5 | 2 | 1 | 0 |
| 38 | 3 | 5 | 2 | 1 | 0 |
| 39 | 3 | 5 | 2 | 1 | 0 |
| 40 | 4 | 5 | 2 | 1 | 0 |
| 41 | 4 | 5 | 2 | 1 | 0 |
| 42 | 5 | 6 | 3 | 1 | 0 |
| 43 | 5 | 6 | 3 | 1 | 0 |
| 44 | 6 | 6 | 3 | 1 | 0 |
| 45 | 6 | 6 | 3 | 1 | 0 |
| 46 | 7 | 6 | 3 | 1 | 0 |
| 47 | 7 | 6 | 3 | 1 | 0 |
| 48 | 0 | 6 | 3 | 1 | 0 |
| 49 | 0 | 7 | 3 | 1 | 0 |
| 50 | 1 | 7 | 3 | 1 | 0 |
| 51 | 1 | 7 | 3 | 1 | 0 |
| 52 | 2 | 7 | 3 | 1 | 0 |
| 53 | 2 | 7 | 3 | 1 | 0 |
| 54 | 3 | 7 | 3 | 1 | 0 |
| 55 | 3 | 7 | 3 | 1 | 0 |
| 56 | 4 | 0 | 4 | 2 | 1 |
| 57 | 4 | 0 | 4 | 2 | 1 |
| 58 | 5 | 0 | 4 | 2 | 1 |
| 59 | 5 | 0 | 4 | 2 | 1 |
| 60 | 6 | 0 | 4 | 2 | 1 |
| 61 | 6 | 0 | 4 | 2 | 1 |
| 62 | 7 | 0 | 4 | 2 | 1 |
| 63 | 7 | 1 | 4 | 2 | 1 |
| 64 | 0 | 1 | 4 | 2 | 1 |
| 65 | 0 | 1 | 4 | 2 | 1 |
| 66 | 1 | 1 | 4 | 2 | 1 |
| 67 | 1 | 1 | 4 | 2 | 1 |
| 68 | 2 | 1 | 4 | 2 | 1 |
| 69 | 2 | 1 | 4 | 2 | 1 |
| 70 | 3 | 2 | 5 | 2 | 1 |
| 71 | 3 | 2 | 5 | 2 | 1 |
| 72 | 4 | 2 | 5 | 2 | 1 |
| 73 | 4 | 2 | 5 | 2 | 1 |
| 74 | 5 | 2 | 5 | 2 | 1 |
| 75 | 5 | 2 | 5 | 2 | 1 |
| 76 | 6 | 2 | 5 | 2 | 1 |
| 77 | 6 | 3 | 5 | 2 | 1 |
| 78 | 7 | 3 | 5 | 2 | 1 |
| 79 | 7 | 3 | 5 | 2 | 1 |
| 80 | 0 | 3 | 5 | 2 | 1 |
| 81 | 0 | 3 | 5 | 2 | 1 |
| 82 | 1 | 3 | 5 | 2 | 1 |
| 83 | 1 | 3 | 5 | 2 | 1 |
| 84 | 2 | 4 | 6 | 3 | 1 |
| 85 | 2 | 4 | 6 | 3 | 1 |
| 86 | 3 | 4 | 6 | 3 | 1 |
| 87 | 3 | 4 | 6 | 3 | 1 |
| 88 | 4 | 4 | 6 | 3 | 1 |
| 89 | 4 | 4 | 6 | 3 | 1 |
| 90 | 5 | 4 | 6 | 3 | 1 |

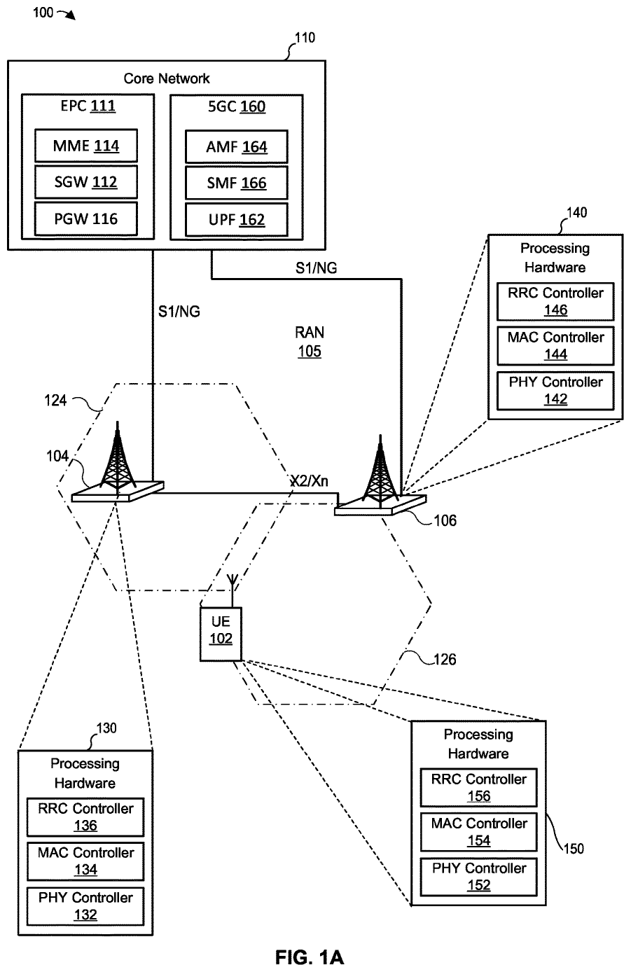

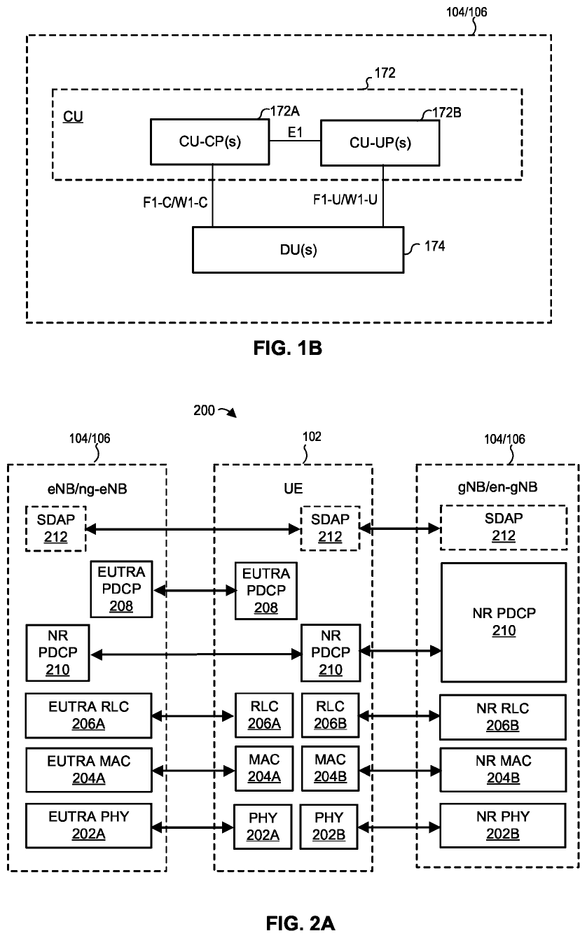

FIG. 1A depicts an example wireless communication system 100 in which communication devices can implement these techniques. The wireless communication system 100 includes a UE 102, a base station 104, a base station 106 and a core network (CN) 110. The UE 102 initially connects to the base station 104. In some scenarios, the base station 104 can perform an SN addition to configure the UE 102 to operate in dual connectivity (DC) with the base station 104 and the base station 106. The base stations 104 and 106 operate as an MN and an SN for the UE 102, respectively.

In various configurations of the wireless communication system 100, the base station 104 can be implemented as a master eNB (MeNB) or a master gNB (MgNB), and the base station 106 can be implemented as a secondary gNB (SgNB). The UE 102 can communicate with the base station 104 and the base station 106 via the same RAT such as EUTRA or NR, or different RATs. When the base station 104 is an MeNB and the base station 106 is a SgNB, the UE 102 can be in EUTRA-NR DC (EN-DC) with the MeNB and the SgNB.

In some cases, an MeNB or an SeNB is implemented as an ng-eNB rather than an eNB. When the base station 104 is a Master ng-eNB (Mng-eNB) and the base station 106 is a SgNB, the UE 102 can be in next generation (NG) EUTRA-NR DC (NGEN-DC) with the Mng-eNB and the SgNB. When the base station 104 is an MgNB and the base station 106 is an SgNB, the UE 102 may be in NR-NR DC (NR-DC) with the MgNB and the SgNB. When the base station 104 is an MgNB and the base station 106 is a Secondary ng-eNB (Sng-eNB), the UE 102 may be in NR-EUTRA DC (NE-DC) with the MgNB and the Sng-eNB.

In the scenarios where the UE 102 hands over from the base station 104 to the base station 106, the base stations 104 and 106 operate as the source base station (S-BS) and a target base station (T-BS), respectively. The UE 102 can operate in DC with the base station 104 and an additional base station (not shown in FIG. 1A) for example prior to the handover. The UE 102 can continue to operate in DC with the base station 106 and the additional base station or operate in single connectivity (SC) with the base station 106, after completing the handover. The base stations 104 and 106 in this case operate as a source MN (S-MN) and a target MN (T-MN), respectively.

A core network (CN) 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. To directly exchange messages with each other during the scenarios discussed below, the base stations 104 and 106 can support an X2 or Xn interface. Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage Protocol Data Unit (PDU) sessions.

As illustrated in FIG. 1A, the base station 104 supports cell 124, and the base station 106 supports a cell 126. The cells 124 and 126 can partially overlap, so that the UE 102 can communicate in DC with the base station 104 and the base station 106, where one of the base stations 104 and 106 is an MN and the other is an SN. The base station 104 and base station 106 can support additional cell(s) (not shown in FIG. 1A). The base station 104 can operate the cells 124 and/or additional cell(s) via one or more transmit and receive points (TRPs). More particularly, when the UE 102 is in DC with the base station 104 and the base station 106, one of the base stations 104 and 106 operates as an MeNB, an Mng-eNB or an MgNB, and the other operates as an SgNB or an Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1A, the base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical downlink (DL) channels and DL reference signals with one or more user devices (e.g., UE 102) via one or more cells and/or one or more TRPs. The PHY controller 132 is also configured to receive data and control signal on physical uplink (UL) channels and/or UL reference signals with the one or more user devices via one or more cells and/or one or more TRPs. The processing hardware 130 in an example implementation includes a MAC controller 134 configured to perform MAC functions with one or more user devices. The MAC functions include a random access (RA) procedure, managing UL timing advance for the one or more user devices, and/or communicating UL/DL MAC PDUs with the one or more user devices. The processing hardware 130 can further include an RRC controller 136 to implement procedures and messaging at the RRC sublayer of the protocol communication stack. For example, the RRC controller 132 may be configured to support RRC messaging associated with handover procedures, and/or to support the necessary operations when the base station 104 operates as an MN relative to an SN or as an SN relative to an MN. The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells and/or one or more TRPs. The PHY controller 152 is also configured to transmit data and control signal on physical UL channels and/or UL reference signals with the base station 104 or 106 via one or more cells and/or one or more TRPs. The processing hardware 150 in an example implementation includes a MAC controller 154 configured to perform MAC functions with base station 104 or 106. For example, the MAC functions include a random-access procedure, managing UL timing advance for the one or more user devices, and communicating UL/DL MAC PDUs with the base station 104 or 106. The processing hardware 150 can further include an RRC controller 156 to implement procedures and messaging at the RRC sublayer of the protocol communication stack.

In operation, the UE 102 in DC can use a radio bearer (e.g., a DRB or an SRB) that at different times terminates at the MN 104 or the SN 106. The UE 102 can apply one or more security keys when communicating on the radio bearer, in the uplink (UL) (from the UE 102 to a base station) and/or downlink (from a base station to the UE 102) direction.

FIG. 1B depicts an example distributed implementation of a base station such as the base station 104 or 106. The base station in this implementation can include a centralized unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an SN RRC controller 142 configured to manage or control one or more RRC configurations and/or RRC procedures when the base station 106 operates as an SN. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random-access procedure) and a radio link control (RLC) controller configured to manage or control one or more RLC operations or procedures when the base station 106 operates as an MN or an SN. The process hardware may include further a physical layer controller configured to manage or control one or more physical layer operations or procedures.

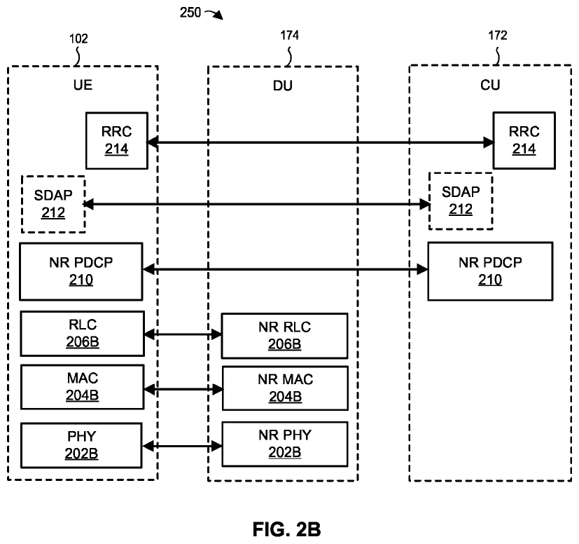

Next, FIG. 2 illustrates in a simplified manner a radio protocol stack according to which the UE 102 can communicate with an eNB/ng-eNB or a gNB. Each of the base stations 104 or 106 can be the eNB/ng-eNB or the gNB.

The physical layer (PHY) 202A of EUTRA provides transport channels to the EUTRA Medium Access Control (MAC) sublayer 204A, which in turn provides logical channels to the EUTRA Radio Link Control (RLC) sublayer 206A, and the EUTRA RLC sublayer in turn provides RLC channels to the EUTRA PDCP sublayer 208 and, in some cases, NR PDCP sublayer 210. Similarly, the PHY 202B of NR provides transport channels to the NR MAC sublayer 204B, which in turn provides logical channels to the NR RLC sublayer 206B, and the NR RLC sublayer 206B in turn provides RLC channels to the NR PDCP sublayer 210. The UE 102 in some implementations supports both the EUTRA and the NR stack, to support handover between EUTRA and NR base stations and/or DC over EUTRA and NR interfaces. Further, as illustrated in FIG. 2A, the UE 102 can support layering of NR PDCP 210 over EUTRA RLC 206A.

The EUTRA PDCP sublayer 208 and the NR PDCP sublayer 210 receive packets (e.g., from the Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 provide SRBs to exchange Radio Resource Control (RRC) messages, for example. On a user plane, the EUTRA PDCP sublayer 208 and the NR PDCP sublayer 210 provide DRBs to support data exchange.

When the UE 102 operates in EUTRA/NR DC (EN-DC), with the base station 104 operating as a MeNB and the base station 106 operating as a SgNB, the network can provide the UE 102 with an MN-terminated bearer that uses EUTRA PDCP 208 or MN-terminated bearer that uses NR PDCP 210. The network in various scenarios also can provide the UE 102 with an SN-terminated bearer, which use only NR PDCP 210. The MN-terminated bearer can be an MCG bearer or a split bearer. The SN-terminated bearer can be a SCG bearer or a split bearer. The MN-terminated bearer can be an SRB (e.g., SRB1 or SRB2) or a DRB. The SN-terminated bearer can an SRB (e.g., SRB) or a DRB.

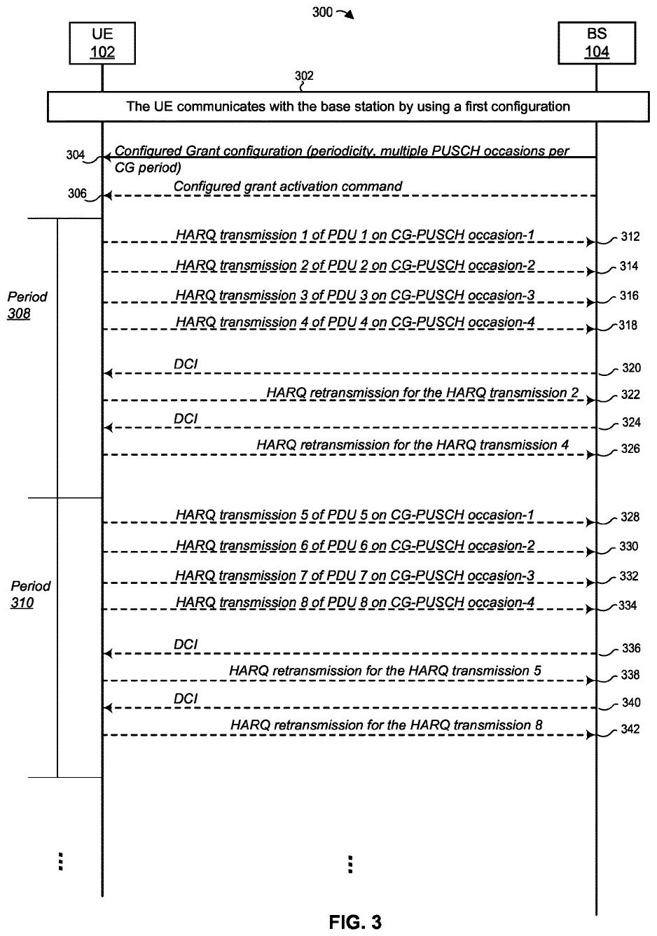

Referring first to FIG. 3, in a scenario 300, the UE 102 initially communicates 302 with the base station 104 using a first configuration. In some implementations, the UE 102 communicates 302 with the base station 104 on a licensed spectrum. In some implementations, the UE 102 in carrier aggregation (CA) communicates with the base station 104 on the cell 124 and other cell(s) using the first configuration. In other implementations, the UE 102 communicates with the base station 104 on the cell 124 only. In some implementations, the UE 102 communicates with the base station 104 on the cell 124 and/or other cell(s) via one or multiple TRPs. In some implementations, the cell 124 is a PCell or a PSCell. In such cases, the other cell(s) include SCell(s) and/or additional cell(s) associated with the PCell or an SCell. In other implementations, the cell 124 is an SCell, and one of the other cell(s) is a PCell. In such cases, the remainder of the cells includes SCell(s) and/or additional cell(s) associated with the PCell or an SCell.

In some implementations, the UE 102 transmits UL PDUs and/or UL control signals to the base station 104 on the cell 124 and/or other cell(s) via one or multiple TRPs. In some implementations, the UE 102 communicates UL PDUs and/or DL PDUs with the base station 104 via radio bearers, which, depending on the implementation, include SRBs and/or DRB(s). In further implementations, the base station 104 configures the radio bearers to the UE 102. In some implementations, UL control signals include UL control information, channel state information, hybrid automatic repeat request (HARQ) acknowledgements (ACKs), HARQ negative ACKs, scheduling request(s), and/or sounding reference signal(s). Similarly, depending on the implementation, the UE 102 receives DL PDUs and/or DL control signals from the base station 104 on the cell 124 and/or other cell(s) via one or multiple TRPs. In some implementations, the DL control signals include downlink control information (DCIs) and reference signals (e.g., synchronization signal block, channel state information reference signal(s) (CSI-RS(s)), and/or tracking reference signal(s)). In some implementations, the base station 104 transmits the DCIs on physical downlink control channel(s) (PDCCH(s)) monitored by the UE 102, on the cell 124 and/or other cell(s) via one or multiple TRPs.

At a later time, the base station 104 transmits 304 to the UE 102 a message including a Configured Grant (CG) configuration that configures multiple CG-PUSCH occasions per CG period (e.g., 4 CG-PUSCH occasions 312, 314, 316, and 318). For example, the message is an RRC reconfiguration message. In some implementations, the base station 104 configures a periodicity for the CG period. In further implementations, the base station 104 includes a periodicity in the CG configuration to configure the CG period. In some implementations, the base station 104 configures the periodicity to align with at least one UL XR traffic periodicity (30 fps, 60 fps, 90 fps, 120 fps, 240 fps, etc.). In some implementations, specifically defined CG periodicities (i.e., specifically defined CG periodicity values) are specific CG periodicities (e.g., specified in 3GPP TS 38.331), and the specifically defined CG periodicities are a rounding up or down of the UL XR traffic periodicities to the closest orthogonal frequency division multiplexing (OFDM) symbol or slot granularity. In some implementations, the base station 104 sets the periodicity to one of the specifically defined CG periodicity values. In other implementations, the base station 104 sets the periodicity to an existing CG periodicity value (e.g., defined in 3GPP TS 38.331). In some implementations, the UE 102 indicates, to the base station 104, a preferred periodicity based on UL data traffic of the UE 102, while communicating with the base station 104 in the event 302. For example, the UE 102 transmits a UEAssistanceInformation message, including the preferred periodicity, to the base station 104. In some implementations, the base station 104 sets the periodicity in the CG configuration to the preferred periodicity. In some implementations, the CG configuration is a ConfiguredGrantConfig information element (IE) (e.g., defined in 3GPP TS 38.331). In some implementations, in the CG configuration, the base station 104 includes specifically defined configuration parameters configuring the multiple CG-PUSCH occasions to accommodate for UL traffic (e.g., UL XR traffic). In some implementations, the base station 104 includes the specifically defined configuration parameters in an IE (e.g., ConfiguredGrantConfig-Multiple-PUSCH-Occasions) and includes the IE in the CG configuration. In some implementations, the specifically defined parameters include a configuration parameter (e.g., cg-nrofPUSCH-CG-Cycle 410) to indicate the number of the CG-PUSCH occasions configured in the CG period. In further implementations, the base station 104 includes existing parameters cg-nrofPUSCH-InSlot and cg-nrofSlots (e.g., defined in Error! Use the Home tab to apply ZA to the text that you want to appear here.) in the CG configuration to configure the number of the CG-PUSCH occasions per CG period for CG transmissions on a licensed spectrum. As such, techniques (e.g., defined in Error! Use the Home tab to apply ZA to the text that you want to appear here.) where the network only configures the existing parameters cg-nrofPUSCH-InSlot and cg-nrofSlots for CG transmissions on an unlicensed spectrum can be avoided.

In some implementations, after transmitting 304 the CG configuration to the UE 102, the base station 104 transmits 306 a CG activation command to the UE 102 to activate the CG configuration. In some implementations, the CG activation command is a DCI. In further implementations, the CG activation command is a MAC control element (CE). After (e.g., in response to) receiving the CG activation command, the UE 102 starts using the CG configuration to transmit data. In other implementations, the UE 102 starts using the CG configuration to transmit data after (e.g., in response to) receiving the CG configuration. In such cases, the event 306 is omitted. In some implementations, the base station 104 includes a CG (i.e., CG resource configuration) in the CG configuration. In other implementations, the base station 104 includes the CG in the CG activation command.

In some implementations, after receiving the CG configuration or CG activation command, the UE 102 generates one or more PDUs (e.g., MAC PDUs) including UL data, generates a HARQ transmission (e.g., HARQ new transmission) for each of the PDU(s), and transmits the HARQ transmission(s) using the CG on some or all of the CG-PUSCH occasions configured in the CG configuration. For example, if the UE 102 has UL data to transmit for the CG-PUSCH occasion-1, the UE 102 generates PDU 1 including the UL data, generates HARQ transmission 1 from the PDU 1, and transmits 312 the HARQ transmission 1 on the CG-PUSCH occasion-1 in CG period 308. If the UE 102 has UL data to transmit for the CG-PUSCH occasion-2, the UE 102 generates PDU 2 including the UL data, generates HARQ transmission 2, and transmits 314 the HARQ transmission 2 on the CG-PUSCH occasion-2 in CG period 308. If the UE 102 has UL data to transmit for the CG-PUSCH occasion-3, the UE 102 generates PDU 3 including the UL data, generates HARQ transmission 3, and transmits 316 the HARQ transmissions 3 on the CG-PUSCH occasion-3 in CG period 308. If the UE 102 has UL data to transmit for the CG-PUSCH occasion-4, the UE 102 generates PDU 4 including the UL data, generates HARQ transmission 4, and transmits 318 the HARQ transmissions 4 on the CG-PUSCH occasion-4 in CG period 308. In some implementations, the HARQ transmissions 1, 2, 3, 4 are HARQ new transmissions or HARQ transmissions with redundancy version 0. In some implementations, the UE 102 has no UL data to transmit on a CG-PUSCH occasion (e.g., the CG-PUSCH occasion-1). In some such cases, the UE 102 skips the CG-PUSCH occasion. Alternatively, the UE 102 generates a PDU (e.g., MAC PDU) including padding bits without data, generates a HARQ transmission from the PDU, and transmits the HARQ transmission on the CG-PUSCH occasion. In some implementations, if the UE 102 has no UL data to transmit on a CG-PUSCH occasion and has uplink control information (UCI) to transmit, the UE 102 does not skip the CG-PUSCH occasion. In some such cases, the UE 102 generates a PDU (e.g., MAC PDU) including padding bits without data, generates a HARQ transmission from the PDU, and transmits the HARQ transmission and the UCI on the CG-PUSCH occasion.

In some scenarios or implementations, if the base station 104 fails to receive PDU(s) from HARQ transmission(s) that UE 102 transmitted on CG-PUSCH occasion(s) in a CG period, the base station 104 transmits one or more DCIs to command the UE 102 to transmit one or more HARQ retransmissions of the PDU(s). In some implementations, each of the DCJ(s) include a redundancy version 0, 1, 2, or 3. In other implementations, each of the DCI(s) includes a redundancy version with a value other than 0. For example, the value is set to 1, 2, or 3. For example, if the base station 104 fails to receive the PDU 2 and PDU 4 from the HARQ transmission 2 and HARQ transmission 4, respectively, the base station 104 transmits 320, to the UE 102, a first DCI that commands the UE 102 to transmit a HARQ retransmission for the HARQ transmission 2 and a HARQ retransmission for the HARQ transmission 4. In accordance with the first DCI, the UE 102 transmits 322 a HARQ retransmission for the HARQ transmission 2 and transmits 326 a HARQ retransmission for the HARQ transmission 4 to the base station 104. In some implementations, the first DCI includes a dynamic grant for the two HARQ retransmissions, and the UE 102 transmits 322 the first HARQ retransmission and 326 the second HARQ retransmission in accordance with the dynamic grant. In other implementations, the first DCI includes a first dynamic grant and a second dynamic grant for the HARQ retransmission for the HARQ transmission 2 and the HARQ retransmission for the HARQ transmission 4, respectively. In such cases, the UE 102 transmits 322 the first HARQ transmission and 326 the second HARQ retransmission in accordance with the first dynamic grant and second dynamic grant, respectively.

In further examples, the base station 104 transmits 320, to the UE 102, a second DCI that commands the UE 102 to transmit a HARQ retransmission for the HARQ transmission 2 and transmits 324, to the UE 102, a third DCI that commands the UE 102 to transmit a HARQ retransmission for the HARQ transmission 4. The UE 102 transmits 322 a HARQ retransmission and transmits 326 a HARQ retransmission for the HARQ transmission 2 and HARQ transmission 4 in accordance with the second DCI and the third DCI, respectively. In some implementations, the second DCI includes a single dynamic grant, and the UE 102 transmits 322 the HARQ retransmission in accordance with the dynamic grant. In some implementations, the third DCI includes a single dynamic grant, and the UE 102 transmits 326 the HARQ retransmission in accordance with the dynamic grant.

In some implementations, if the base station 104 determines that the UE 102 supports a single DCI (e.g., a particular DCI format) scheduling multiple PUSCH transmissions, the base station 104 determines to transmit or transmits, to the UE 102, a single DCI that commands the UE 102 to transmit multiple HARQ retransmissions for HARQ transmissions that the UE 102 transmits on CG-PUSCH occasions. For example, the base station 104 transmits the first DCI because the UE 102 supports a single DCI (e.g., a particular DCI format) scheduling multiple PUSCH transmissions. Otherwise, if the base station 104 determines that the UE 102 does not support a single DCI (e.g., a particular DCI format) scheduling multiple PUSCH transmissions, the base station 104 determines to transmit or transmits, to the UE 102, a DCI that commands the UE 102 to transmit a HARQ retransmission for a HARQ transmission that the UE 102 transmits on a CG-PUSCH occasion. For example, the base station 104 transmits the second DCI and third DCI because the UE 102 does not support a single DCI (e.g., a particular DCI format) scheduling multiple PUSCH transmissions.

In some implementations, the base station 104 detects whether the UE 102 skips a CG-PUSCH occasion due to a lack of UL data available for transmission on the CG-PUSCH occasion. If the base station 104 detects a CG-PUSCH occasion skipped by the UE 102, the base station 104 refrains from transmitting a DC that commands the UE 102 to transmit a HARQ retransmission for the CG-PUSCH occasion. For example, if the base station 104 detects the CG-PUSCH occasion-2 skipped by the UE 102, the base station transmits neither the first DCI nor the second DCI. In some implementations, the base station 104 determines whether to enable the UE 102 to skip a CG-PUSCH occasion when the UE 102 has no UL data available for transmission on the CG-PUSCH occasion. In some implementations, if the base station 104 determines that the UE 102 supports skipping a CG-PUSCH occasion among multiple CG-PUSCH occasions in a CG period when the UE 102 has no UL data available for transmission on the CG-PUSCH occasion, the base station 104 enables the UE 102 to skip a CG-PUSCH occasion due to a lack of UL data available for transmission on the CG-PUSCH occasion. If the base station 104 determines that the UE 102 does not support skipping a CG-PUSCH occasion among multiple CG-PUSCH occasions in a CG period when the UE 102 has no UL data to transmit on the CG-PUSCH occasion, the base station 104 disables or refrains from enabling the UE 102 to skip a CG-PUSCH occasion among multiple CG-PUSCH occasions in a CG period when the UE 102 has no UL data to transmit on the CG-PUSCH occasion.

In some implementations, in the next CG period 310, the UE 102 generates one or more PDUs (e.g., MAC PDUs) including UL data, generates a HARQ transmission (e.g., HARQ new transmission) for each of the PDU(s), and transmits the HARQ transmission(s) using the CG on some or all of the CG-PUSCH occasions configured in the CG configuration. For example, if the UE 102 has UL data to transmit for the CG-PUSCH occasion-1, the UE 102 generates PDU 5 including the UL data, generates HARQ transmission 5 from the PDU 5 and transmits 328 the HARQ transmission 5 on the CG-PUSCH occasion-1 in CG period 310. If the UE 102 has UL data to transmit for the CG-PUSCH occasion-2, the UE 102 generates PDU 6 including the UL data, generates HARQ transmission 6, and transmits 330 the HARQ transmission 6 on the CG-PUSCH occasion-2 in CG period 310. If the UE 102 has UL data to transmit for the CG-PUSCH occasion-3, the UE 102 generates PDU 7 including the UL data, generates HARQ transmission 7, and transmits 332 the HARQ transmission 7 on the CG-PUSCH occasion-3 in CG period 310. If the UE 102 has UL data to transmit for the CG-PUSCH occasion-4, the UE 102 generates PDU 4 including the UL data, generates HARQ transmission 4, and transmits 334 the HARQ transmission 4 on the CG-PUSCH occasion-4 in CG period 310. In some implementations, the HARQ transmissions 5, 6, 7, 8 are HARQ new transmissions or HARQ transmissions with redundancy version 0. In some implementations, the UE 102 has no UL data to transmit on a CG-PUSCH occasion (e.g., the CG-PUSCH occasion-6 or CG-PUSCH occasion-7). In some such cases, the UE 102 skips the CG-PUSCH occasion. Alternatively, the UE 102 generates a PDU (e.g., MAC PDU) including padding bits without data, generates a HARQ transmission from the PDU, and transmits the HARQ transmission on the CG-PUSCH occasion. In some implementations, if the UE 102 has no UL data to transmit on a CG-PUSCH occasion and has uplink control information (UCI) to transmit, the UE 102 does not skip the CG-PUSCH occasion. In some such cases, the UE 102 generates a PDU (e.g., MAC PDU) including padding bits without data, generates a HARQ transmission from the PDU, and transmit the HARQ transmission and the UCI on the CG-PUSCH occasion.

In some scenarios or implementations, if the base station 104 fails to receive PDU(s) from HARQ transmission(s) that UE 102 transmitted on CG-PUSCH occasion(s) in a CG period, the base station 104 transmits one or more DCIs to command the UE 102 to transmit one or more HARQ retransmissions of the PDU(s). In some implementations, each of the DCI(s) include a redundancy version with a value set to 0, 1, 2, or 3. In other implementations, each of the DCI(s) include a redundancy version with a value other than 0. For example, the value is set to 1, 2, or 3. For example, if the base station 104 fails to receive the PDU 5 and PDU 8 from the HARQ transmission 5 and HARQ transmission 8, respectively, the base station 104 transmits 336, to the UE 102, a fourth DCI that commands the UE 102 to transmit a HARQ retransmission for the HARQ transmission 5 and a HARQ retransmission for the HARQ transmission 8. In accordance with the fourth DCI, the UE 102 transmits 338 a first HARQ retransmission and transmits 342 a second HARQ retransmission for the HARQ transmission 5 and HARQ transmission 8 to the base station 104, respectively. In some implementations, the fourth DCI includes a dynamic grant for the two HARQ retransmissions, and the UE 102 transmits 338 the first HARQ retransmission and transmits 342 the second HARQ retransmission in accordance with the dynamic grant. In other implementations, the fourth DCI includes a first dynamic grant and a second dynamic grant for the first HARQ retransmission for the HARQ transmission 5 and the second HARQ retransmission for the HARQ transmission 8, respectively. In such cases, the UE 102 transmits 338 the first HARQ retransmission and transmits 342 the second HARQ retransmission in accordance with the first dynamic grant and second dynamic grant, respectively.

In further examples, the base station 104 transmits 336, to the UE 102, a fifth DCI that commands the UE 102 to transmit a HARQ retransmission for the HARQ transmission 5 and transmits 340, to the UE 102, a sixth DCI that commands the UE 102 to transmit a HARQ retransmission for the HARQ transmission 8. The UE 102 transmits 338 a first HARQ retransmission and transmits 342 a second HARQ retransmission for the HARQ transmission 5 and HARQ transmission 8 in accordance with the fifth DCI and the sixth DCI, respectively. In some implementations, the fifth DCI includes a single dynamic grant, and the UE 102 transmits 338 the HARQ retransmission in accordance with the dynamic grant. In some implementations, the sixth DCI includes a single dynamic grant, and the UE 102 transmits 342 the HARQ retransmission in accordance with the dynamic grant.

In some implementations, if the base station 104 determines that the UE 102 supports a single DCI (e.g., a particular DCI format) scheduling multiple PUSCH transmissions, the base station 104 determines to transmit or transmits, to the UE 102, a single DCI that commands the UE 102 to transmit multiple HARQ retransmissions for HARQ transmissions that the UE 102 transmits on CG-PUSCH occasions. For example, the base station 104 transmits the fourth DCI because the UE 102 supports a single DCI (e.g., a particular DCI format) scheduling multiple PUSCH transmissions. Otherwise, if the base station 104 determines that the UE 102 does not support a single DCI (e.g., a particular DCI format) scheduling multiple PUSCH transmissions, the base station 104 determines to transmit or transmits to the UE 102 a DCI that commands the UE 102 to transmit a HARQ retransmission for only a HARQ transmission that the UE 102 transmits on a CG-PUSCH occasion. For example, the base station 104 transmits the fifth DCI and sixth DCI because the UE 102 does not support a single DCI (e.g., a particular DCI format) scheduling multiple PUSCH transmissions.

In some implementations, the base station 104 transmits an enabling indication to the UE 102 to enable the UE 102 to skip a CG-PUSCH occasion among multiple CG-PUSCH occasions in a CG period due to a lack of UL data available for transmission on the CG-PUSCH occasion. For example, the base station 104 includes the enabling indication in the message 304. In further examples, the base station 104 transmits another message (e.g., RRC reconfiguration message), including the enabling indication, to the UE 102. In some implementations, if the UE 102 receives the enabling indication and has no data available for transmission on one of multiple CG-PUSCH occasions in a CG period, the UE 102 skips the CG-PUSCH occasion. Otherwise, if the UE 102 does not receive the enabling indication and has no data available for transmission on one of multiple CG-PUSCH occasions in a CG period, the UE 102 generates a PDU (e.g., MAC PDU) including padding bits without data, generates a HARQ transmission from the PDU, and transmits the HARQ transmission on the CG-PUSCH occasion. Otherwise, if the UE 102 does not receive the enabling indication and has no data available for transmission on one of multiple CG-PUSCH occasions in a CG period, the UE 102 generates a PDU (e.g., MAC PDU) including padding bits without data, generates a HARQ transmission from the PDU, and transmits the HARQ transmission on the CG-PUSCH occasion.

In some implementations, the UE 102 transmits, to the base station 104, a UE capability indicating that the UE 102 supports skipping a CG-PUSCH occasion among multiple CG-PUSCH occasions in a CG period when the UE 102 has no UL data to transmit on the CG-PUSCH occasion. In some implementations, the UE 102 transmits a UE-NR-Capability IE, including the UE capability, to the base station 104. In further implementations, the UE 102 transmits a UE-6G-Capability IE including the UE capability to the base station 104. In other implementations, the base station 104 receives the UE capability from a core network (e.g., AMF) or the base station 106. In some implementations, the base station 104 receives the UE-NR-Capability IE, including the UE capability, from the core network or base station 106. In some implementations, the UE capability is specifically defined (e.g., in 3GPP TS 38.331 and 38.306) and different from the enhancedSkipUplinkTxConfigured-r16 IE (e.g., defined in 3GPP TS 38.331 and 38.306). In some implementations, because the enhancedSkipUplinkTxConfigured-r16 is specified for a legacy CG configuration configuring a single CG-PUSCH occasion per CG period, a UE supporting the enhancedSkipUplinkTxConfigured-r16 does not support skipping a CG-PUSCH occasion among multiple CG-PUSCH occasions in a CG period when the UE 102 has no UL data to transmit on the CG-PUSCH occasion. In other implementations, the UE capability is the enhancedSkipUplinkTxConfigured-r16 IE (e.g., defined in 3GPP TS 38.331 and 38.306). In such cases, the enhancedSkipUplinkTxConfigured-r16 is extended to indicate supporting skipping a CG-PUSCH occasion among multiple CG-PUSCH occasions in a CG period when the UE 102 has no UL data to transmit on the CG-PUSCH occasion.

In some implementations, the base station 104 determines whether to configure multiple CG-PUSCH occasions per CG period for the UE 102 based on whether the UE 102 supports multiple CG-PUSCH occasions per CG period. If the base station 104 determines that the UE 102 supports multiple CG-PUSCH occasions per CG period, the base station 104 transmits 304 the CG configuration to the UE 102. Otherwise, if the base station 104 determines that the UE 102 does not support multiple CG-PUSCH occasions per CG period, the base station 104 does not transmit the CG configuration. In some such cases, the base station 104 transmits a CG configuration configuring a single CG-PUSCH occasion per CG period to the UE 102. For example, the base station 104 includes the CG configuration in the message 304 instead of the CG configuration configuring multiple CG-PUSCH occasions per CG period.

In some implementations, the UE 102 transmits, to the base station 104, a UE capability indicating that the UE 102 supports multiple CG-PUSCH occasions per CG period. In some implementations, the UE 102 transmits a UE-NR-Capability IE, including the UE capability, to the base station 104. In further implementations, the UE 102 transmits a UE-6G-Capability IE, including the UE capability, to the base station 104. In other implementations, the base station 104 receives the UE capability from a core network (e.g., AMF) or the base station 106. In some implementations, the base station 104 receives the UE-NR-Capability IE, including the UE capability, from the core network or base station 106. In some implementations, the UE capability is specifically defined (e.g., in 3GPP TS 38.331 and 38.306).

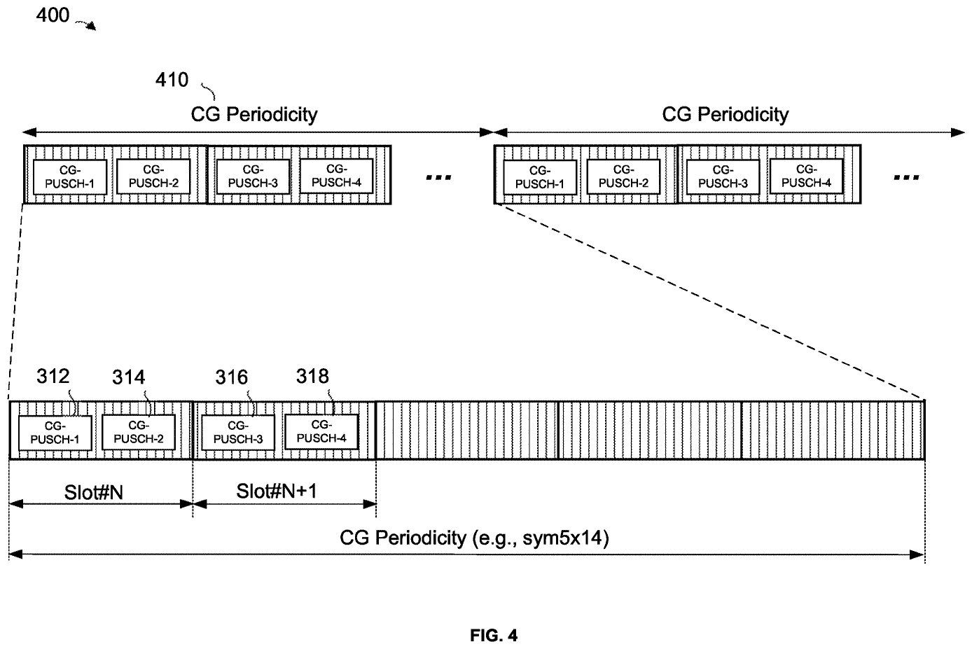

Referring to FIG. 4, the UE 102 is configured with multiple CG-PUSCH occasions per CG period, as described for FIG. 3. In scenario 400 of FIG. 4, four (4) CG-PUSCH occasions 312, 314, 316, and 318 are configured per CG period/periodicity. Depending on the implementation, the CG-PUSCH occasions in a CG period are assigned to one or multiple slots. In some implementations, the allocation is identical in all slots, meaning the same time and frequency resources assigned to the CG-PUSCH occasions in one slot mirror other slots. Alternatively, different frequency and time allocations in each slot are also possible.

In some implementations, if the UE 102 has no UL data to transmit for a CG-PUSCH occasion in a CG period, the UE 102 skips the CG-PUSCH occasion (i.e., the UE 102 skips or refrains from transmitting a CG-PUSCH transmission on the CG-PUSCH occasion). For example, the CG-PUSCH occasion is the CG-PUSCH-1, CG-PUSCH-2, CG-PUSCH-3, or CG-PUSCH-4 occasion. In some implementations, when the UE 102 has UL data to transmit for a first CG-PUSCH occasion right after the skipped CG-PUSCH occasion(s), the UE 102 transmits a skipping indication to the base station 104 to indicate the skipped CG-PUSCH occasion(s) on the first transmitted CG-PUSCH occasion. Based on the skipping indication, the base station 104 determines that the UE 102 skips the one or more consecutive CG-PUSCH occasions instead of determining that CG-PUSCH transmission(s) on the one or more consecutive CG-PUSCH occasions are missing. Without the skipping indication, the base station 104 attempts to schedule the UE 102 to transmit HARQ retransmission(s) for the missing CG-PUSCH transmission(s), because the base station 104 fails to receive CG-PUSCH transmission(s) on the one or more consecutive CG-PUSCH occasions. In some implementations, the UE 102 includes the skipping indication in a CG-PUSCH transmission that the UE 102 transmits on the first CG-PUSCH occasion. In some implementations, the UE 102 transmits uplink control information (UCI), including the skipping indication, with a PUSCH transmission on the first transmitted CG-PUSCH occasion. In other implementations, the UE 102 includes the skipping indication in a MAC CE; includes the MAC CE, subheader of the MAC CE, and UL data in a MAC PDU; generates a PUSCH transmission from the MAC PDU; and transmits the PUSCH transmission on the first CG-PUSCH occasion to base station 104.

In other implementations, if the UE 102 has no UL data to transmit for a CG-PUSCH occasion in a CG period, the UE 102 transmits a PUSCH transmission including no data (i.e., zero-data PUSCH transmission) on the CG-PUSCH occasion. In some implementations, to generate the zero-data PUSCH transmission, the UE 102 generates a MAC PDU, including padding bits without data, and generates the zero-data PUSCH transmission from the MAC PDU. In some implementations, the base station 104 configures whether the UE 102 can skip transmitting a PUSCH transmission on a CG-PUSCH occasion.

In some implementations, the base station 104 includes, in the CG configuration configuring multiple CG-PUSCH occasions, an indication to indicate that the UE 102 can skip a CG-PUSCH occasion when there is no UL data for transmission for the CG-PUSCH occasion. In some implementations, if the CG configuration includes the indication, the UE 102 skips transmitting a PUSCH transmission on a CG-PUSCH occasion when the UE 102 has no UL data to transmit. Otherwise, if the CG configuration does not include the indication, the UE 102 transmits a zero-data PUSCH transmission on a CG-PUSCH occasion when the UE 102 has no UL data for transmission.

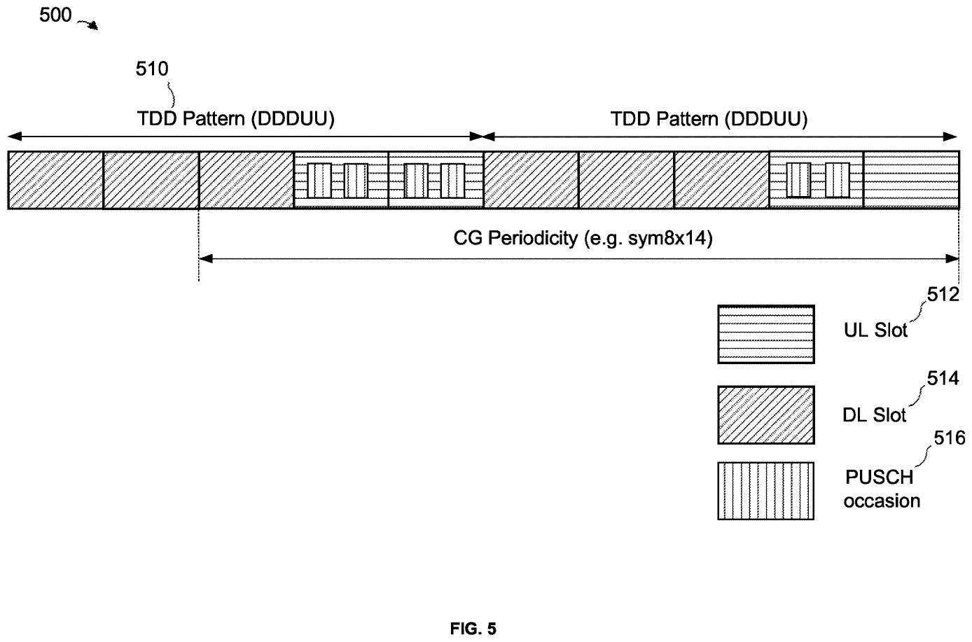

Referring next to FIG. 5, in a scenario 500 implemented in a time division duplex (TDD) mode, the number of CG-PUSCH occasions can be specified to be counted only on UL slots 512, and the counter (i.e., for the number of CG-PUSCH occasions) does not increment for DL slots. For example, if the number of CG-PUSCH occasions configured in the CG period is equal to 6 as shown in FIG. 5 (e.g., 6 CG PUSCH occasions per CG cycle split across two successive TDD patterns), and the TDD pattern is three downlink and two uplink slots (DDDUU), the UE 102 skips downlink slots 514 for the counting of the CG-PUSCH occasions 516.

In some implementations, if the UE 102 and/or base station 104 are to reuse existing parameters cg-nrofPUSCH-InSlot and cg-nrofSlots (e.g., defined in Error! Use the Home tab to apply ZA to the text that you want to appear here.) to configure multiple PUSCH transmission occasions per CG period on a licensed spectrum, then, in TDD mode, cg-nrofSlots are specified to be counted only on UL slots, and the counter does not increment for DL slots. For example, if cg-nrofSlots is equal to 4, and the TDD pattern is DDDUU, then cg-nrofSlots is counted over two successive TDD patterns. In another example implementation, the UE 102 and/or base station 104 uses a bitmap to indicate the slot to be used for the CG-PUSCH occasions, and the size of the bitmap is, in some implementations, equal to the CG periodicity in slots. In some implementations, the base station 104 configures the UE 102 with the bitmap (e.g., via RRC). A value of ‘1’ in the bitmap indicates that CG-PUSCH occasions are allowed in the corresponding slot, and a value of ‘0’ indicates that CG-PUSCH occasions are not allowed in the corresponding slot. In some implementations, in TDD mode, CG-PUSCH occasions are allowed in the intersection between the allowed slots in the bitmap and the UL slots of the TDD pattern.

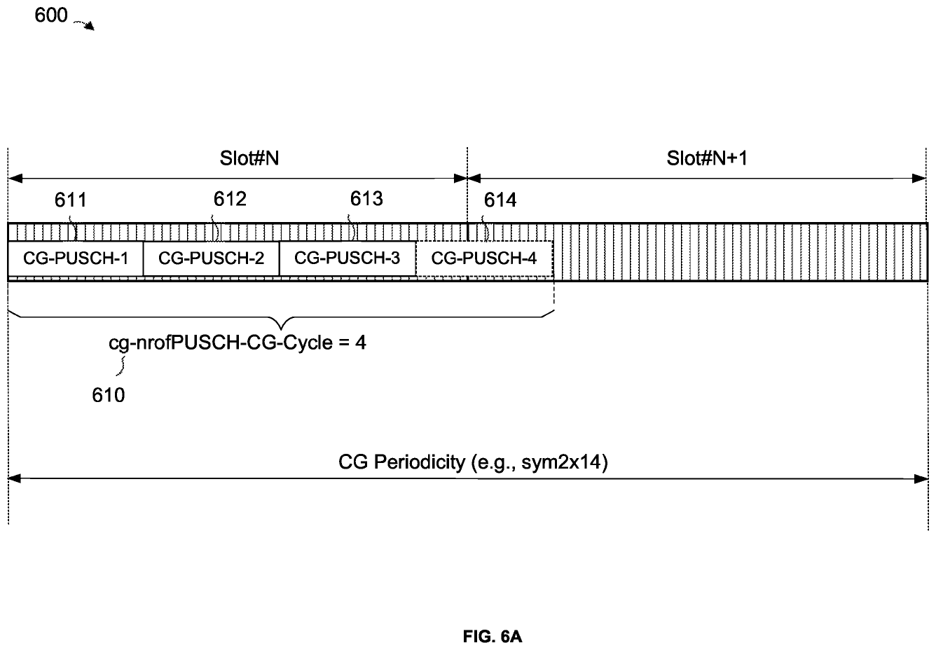

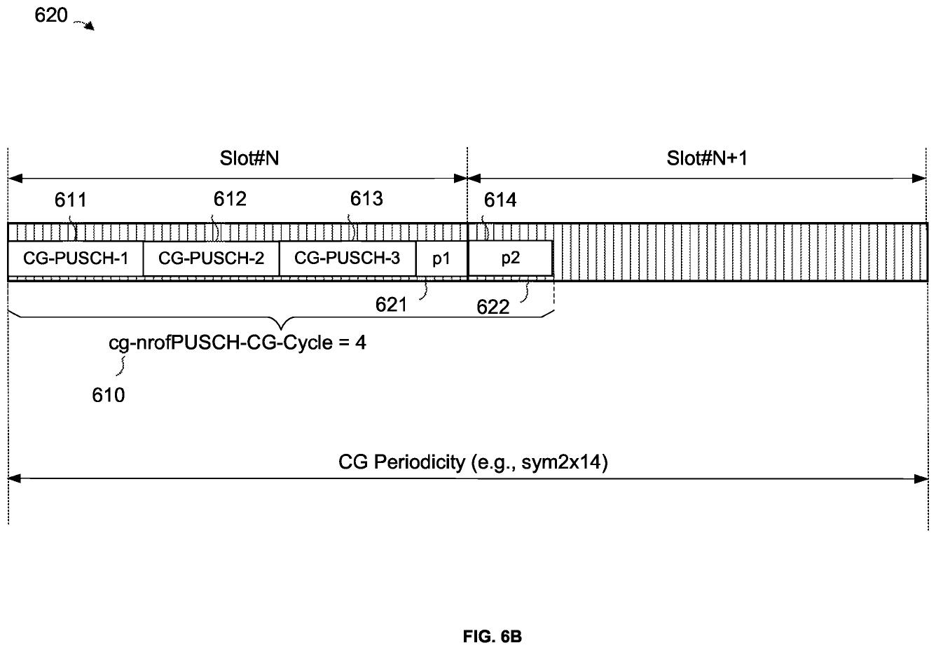

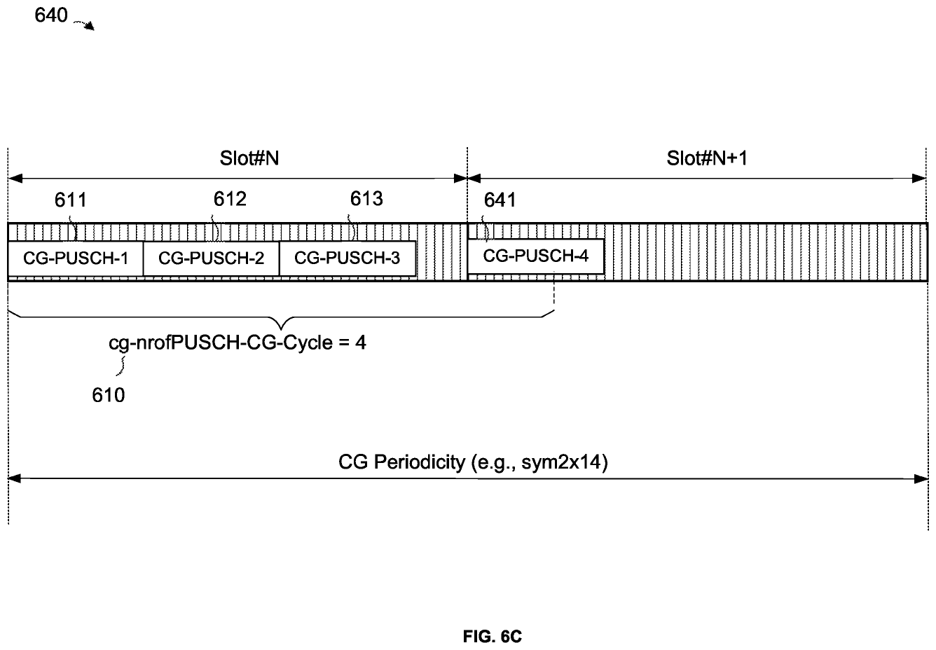

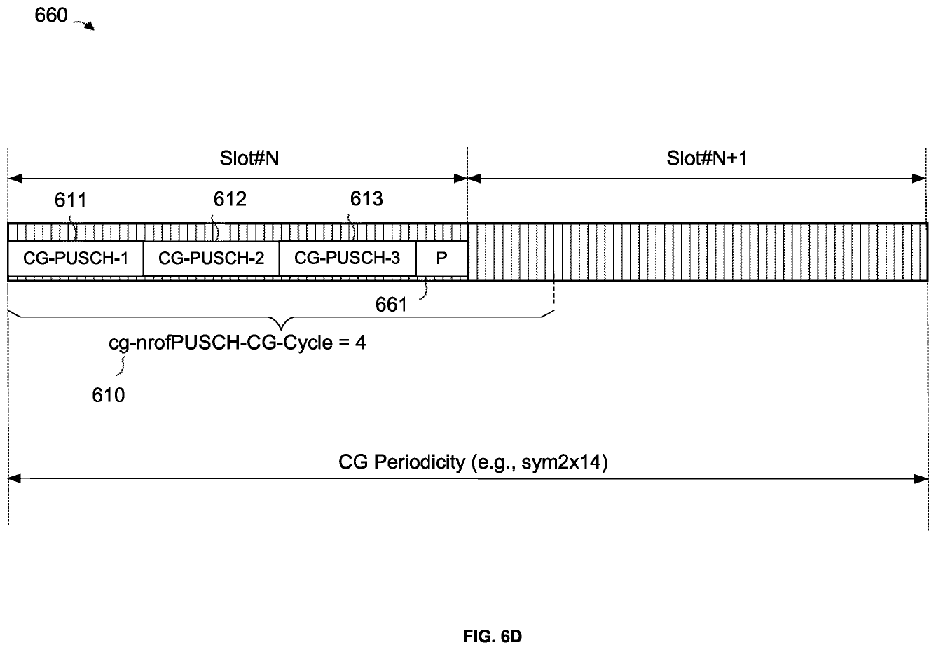

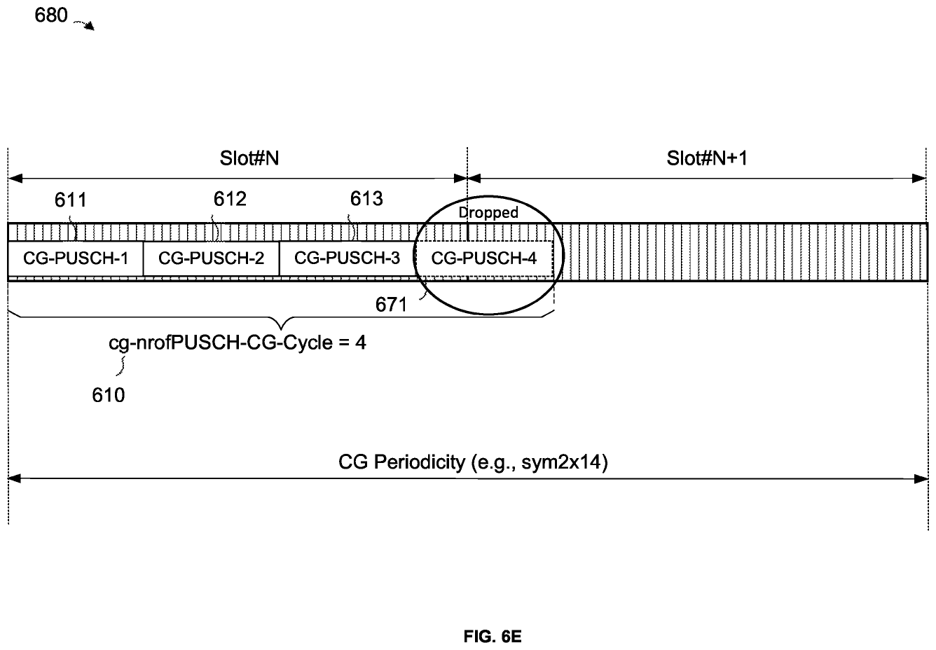

Referring next to FIGS. 6A-6E, the CG-PUSCH occasions in the CG period can be back-to-back. For example, as shown in scenario 600 of FIG. 6A, CG-PUSCH occasions 611, 612, 613, and 614 are back-to-back without any gaps between the different CG-PUSCH occasions. However, in some implementations, such an arrangement leads to CG-PUSCH occasions crossing the slot boundary, as shown in FIG. 6A, with CG-PUSCH occasion 4 in 614 crossing the boundary between slot #N and slot #N+1. In some implementations, as shown in scenario 620 of FIG. 6B, if a CG-PUSCH occasion crosses the slot boundary, then the UE 102 and/or base station 104 segments the CG-PUSCH occasion into two segments 621 and 622, one segment in the initial slot (e.g., slot #N) and one segment in the following slot (e.g., slot #N+1). In further implementations, as shown in scenario 640 of FIG. 6C, if a CG-PUSCH occasion crosses the slot boundary, then the UE 102 and/or base station 104 shifts the CG-PUSCH occasion from slot #N to the start of the following slot slot N+1, as in occasion 641. In still further implementations, as shown in scenario 660 of FIG. 6D, if a CG-PUSCH occasion crosses the slot boundary, then the UE 102 and/or base station 104 rate matches the CG-PUSCH occasion to fit in the remaining symbols of slot #N, as in occasion 661. In yet still further implementations, as shown in scenario 680 of FIG. 6E, if a CG-PUSCH occasion crosses the slot boundary, then the UE 102 and/or base station 104 drops and refrains from using the CG-PUSCH occasion 671 for the transmission.

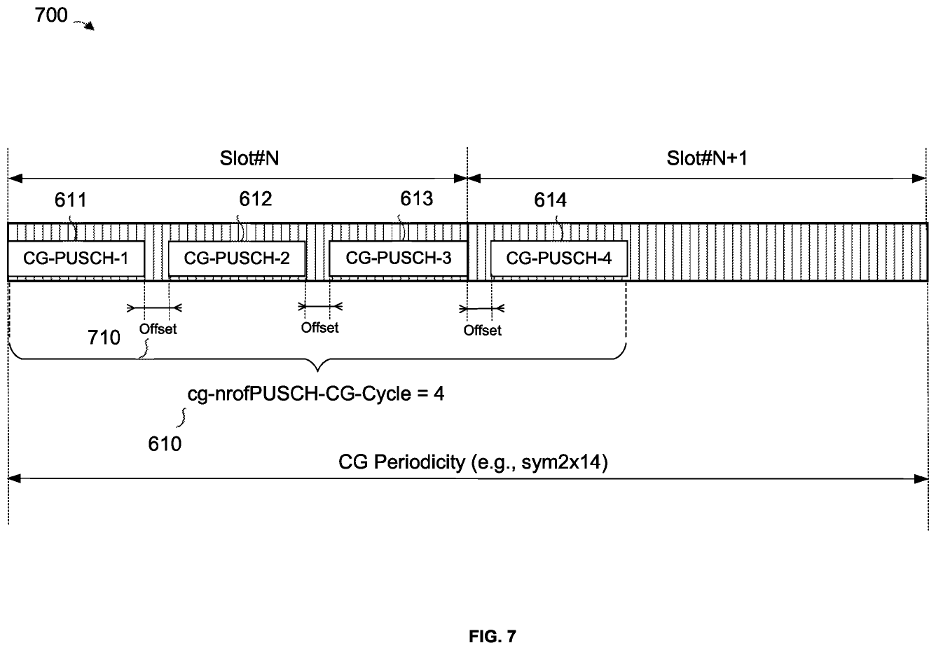

Referring next to FIG. 7, specifically defined PUSCH offsets for the CG-PUSCH occasions for the UL XR traffic are illustrated in a scenario 700. The base station 104 configures the UE 102 with multiple PUSCH offsets. The UE 102 uses the PUSCH offsets to determine the location in time (e.g., temporal location) of the different CG-PUSCH occasions in the CG period. A PUSCH offset consists of a starting time offset for the CG-PUSCH occasion from a specific reference. In some implementations, the reference is the last symbol of a previous PUSCH in the CG period, as shown in offset 710. In further implementations, the reference is the start symbol of the CG resources, the start boundary of the CG period, etc. Depending on the implementation, an RRC parameter (e.g., cg-offset-CG-PUSCH-Occasions) is specifically defined to indicate the offset between the CG-PUSCH occasions. As such, in some implementations, the RRC parameter indicates the starting time of the different CG-PUSCH occasions, and the offset is defined as the duration in symbols between the end of one CG-PUSCH occasion and the start of the next CG-PUSCH occasion, or the offset between the start of two successive CG-PUSCH occasions. In further implementations, the offset is defined in slots between the start of two successive CG-PUSCH occasions. In some implementations, such a field is indicated when multiple PUSCH transmission occasions per CG period are enabled for the XR traffic. In some implementations, if using the offset will lead to a CG-PUSCH occasion crossing the slot boundary, then the UE 102 and/or base station 104 cancels, truncates, segments, or shifts (e.g., to the start of the next slot) the CG-PUSCH occasion. In further implementations, the UE 102 and/or base station 104 applies the offset between CG-PUSCH occasions only to CG-PUSCH occasions belonging to the same slot. In some implementations, if using the offset will lead to a CG-PUSCH occasion crossing the TDD UL/DL boundary, then the UE 102 and/or base station 104 cancels, truncates, segments, or shifts (e.g., to the start of the next UL slot) the CG-PUSCH.

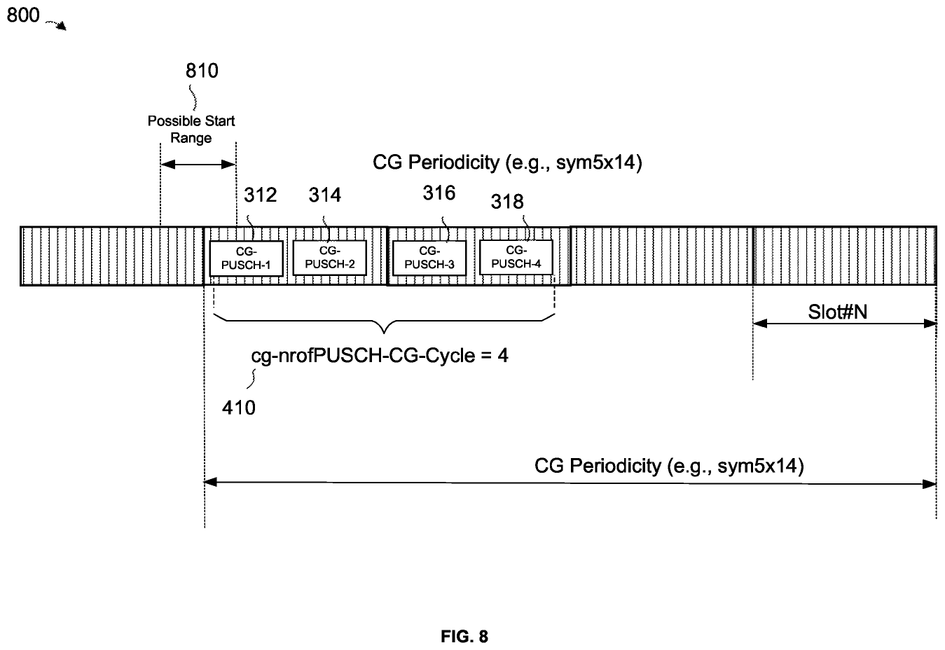

Referring next to FIG. 8, the UE 102 in a scenario 800 can start the UL transmission later or earlier then the start symbol indicated by the configured grant configuration and within a specified or configured interval labelled ‘possible start range’ 810. In some implementations, the base station 104 and/or UE 102 enables such a feature if the UE 102 is experiencing an UL jitter (e.g., from the video codec), and the UE 102, in further implementations, reports, to the base station 104, information about the jitter (e.g., jitter statistics). In still further implementations, the UE 102 also requests that the base station 104 enable such a feature. In some implementations, the interval/range is defined in terms of number of symbols, slots, etc., and the UE 102 in some implementations starts the transmission before or after the configured starting time while complying with the configured interval/range. The base station 104 configures the UE 102 with the interval/range for the flexible UL transmission. In some implementations, the UE 102 reports, to the base station 104, the preferred values of the range depending on the experienced jitter. In further implementations, in cases with a negative jitter, the UE 102 delays the start to align with the configured start of the CG resources. In other words, the negative jitter is not considered, and the start is not advanced for a negative jitter. In further implementations, in cases regarding positive jitter, the UE 102 leaves few symbols empty until the actual start of the UL transmission, the UE 102 sends UL DMRS only without data, the UE 102 skips the first one or multiple CG-PUSCH occasions in the CG period, or the UE 102 pads the start with random data in order to still start at the configured start of the CG resources.

In some implementations, the base station 104 configures the UE 102 with multiple starting offsets to select from to transmit the first CG-PUSCH occasion in the CG period. In alternative implementations, the base station 104 configures the UE 102 with multiple starting offsets for each CG-PUSCH occasion in the CG period, and the UE 102 has the flexibility to select the suitable offset for each CG-PUSCH occasion depending on the UL jitter the UE is experiencing.

In some implementations, different CG-PUSCH occasions in the CG period have different time durations. In some implementations, a specifically defined RRC parameter (e.g., timeDomainAllocation-CG-PUSCH-Occasions) for the base station 104 indicates, to the UE 102, the time domain resource allocation for each CG-PUSCH occasion in the CG period. For example, the base station 104 indicates, to the UE 102, the combination of start symbol and length and/or PUSCH mapping type for each CG-PUSCH occasion in the CG period. Such an indication therefore saves resources when different CG-PUSCH occasions are to have different durations. In further implementations, the field indicates the combination of start symbol and length and/or PUSCH mapping type for the first CG-PUSCH occasion in the CG period, and the time domain allocations for the remaining CG-PUSCH occasions are derivable from the first CG-PUSCH occasion with a time offset. In still further implementations, the field indicates the combination of start symbol and length and/or PUSCH mapping type for the CG-PUSCH occasions in one slot of the CG period, and the time domain allocations for the remaining slots are derivable from the time domain allocation in the first slot and replicated to the other slots. In some implementations, the time offset is RRC configured as part of the ConfiguredGrantConfig information element or as part of a specifically defined RRC parameter structure. In some implementations, if the field is present, the UE ignores timeDomainAllocation field. In further implementations, the field is indicated when multiple PUSCH transmission occasions per CG period are enabled in the licensed spectrum operation and/or when XR traffic is scheduled (e.g., when PDU-Sets/Data-Bursts are scheduled).

In some implementations, different CG-PUSCH occasions in the CG period have different frequency domain resource allocations. In some implementations, a specifically defined RRC parameter (e.g., frequencyDomainAllocation-CG-PUSCH-Occasions) indicates the frequency domain resource allocation for each CG-PUSCH occasion in the CG period. In some implementations, such an RRC parameter improves resource usage and reliability if different CG-PUSCH occasions are to have different frequency domain allocations (e.g., to avoid frequency selectivity affecting a specific frequency). In some implementations, if the field is present, the UE ignores the frequencyDomainAllocation field. In further implementations, the field is indicated when multiple PUSCH transmission occasions per CG period are enabled and/or when XR traffic is scheduled (e.g., when PDU-Sets/Data-Bursts are scheduled).

In some implementations, the base station 104 signals, to the UE 102, the offset of each CG-PUSCH occasion in the CG period with respect to the reference SFN. In some implementations, a specifically defined RRC parameter (e.g., tineDomainOffset-CG-PUSCH-Occasions) indicates the offset for each CG-PUSCH occasion in the CG period and is related to the reference SFN indicated by timeReferenceSFN (e.g., as described in Error! Use the Home tab to apply ZA to the text that you want to appear here.). In particular, the UE 102 uses the closest SFN with the indicated number preceding the reception of the configured grant configuration and, if the field timeReferenceSFN is not present, the reference SFN is 0. In some implementations, if the field is present, the UE 102 ignores the timeDomainOffpet field. In some implementations, the field is indicated when multiple PUSCH transmission occasions per CG period are enabled, when XR traffic is scheduled, and/or when PDU-Sets/Data-Bursts are scheduled.

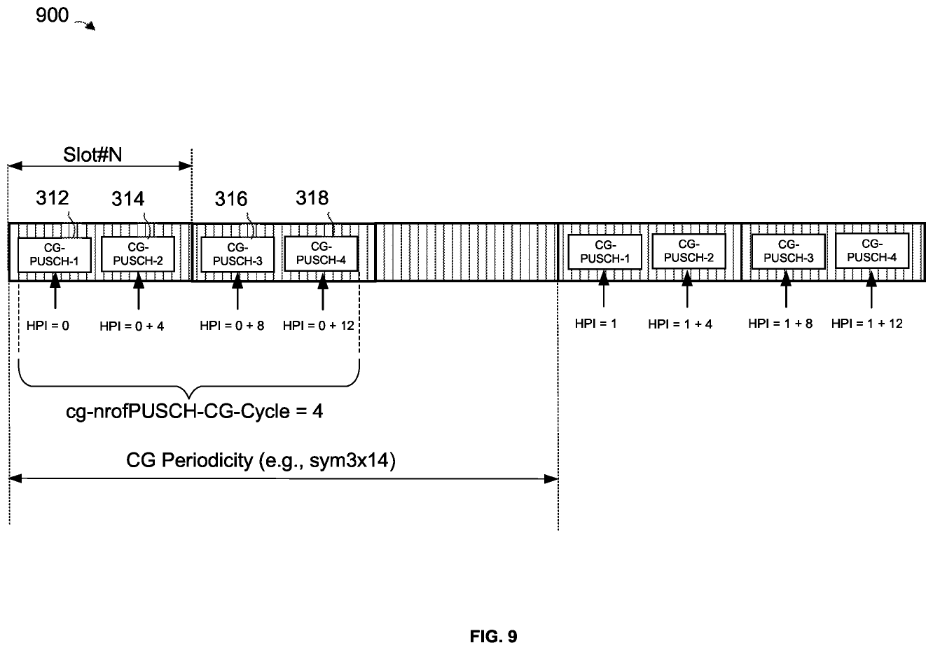

Referring next to FIG. 9, in a scenario 900, a HARQ Process Identifier formula (HPI=[floor(CURRENT_symbol/periodicity)]modulo nrofHARQ-Processes) uses an offset for each CG-PUSCH occasion index in the CG period. For example, the formula is defined as HPI=[floor(CURRENT_symbol/periodicity)+HARQ_offset-k]modulo nrofHARQ-Processes, where the HARQ_offset-k is indicated from the base station 104 to the UE 102 for each CG-PUSCH occasion index (e.g., for the first CG-PUSCH occasion HARQ_offset-0=0, for the second CG-PUSCH occasion HARQ_offset-1=4, for the third CG-PUSCH occasion HARQ_offset-2=8, . . . ). As such, the HPT is representative of the respective CG-PUSCH occasion index and the period (e.g., a first period includes HPI=0+0, HPI=0+4, HPI=0+8, and HPI=0+12, a second period includes HPI=1+0, HPI=1+4, HPI=1+8, HPI=1+12, etc.).

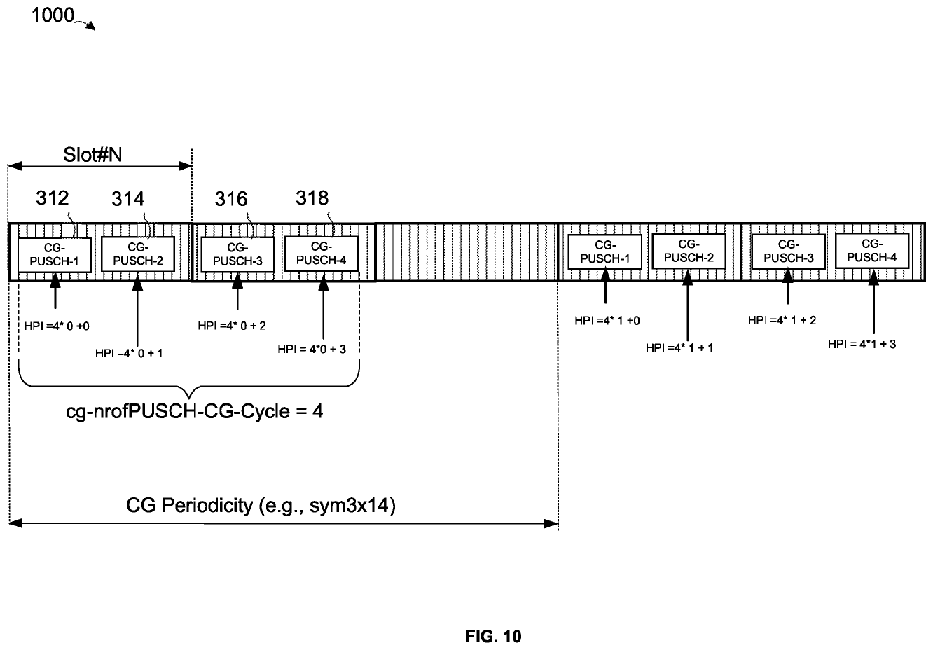

Referring next to FIG. 10, in a scenario 1000 the formula for the HARQ Process ID is defined as HPI=[N*floor(CURRENT_symbol/periodicity)+I]modulo nrofHARQ-Processes, where N defines the number of CG-PUSCH occasions in the CG period, and I is the index of the CG-PUSCH occasion in the CG period. Depending on the implementation, the index I is in the range from 0 to N−1. As such, the HPI is representative of the respective CG-PUSCH occasion index, size of the CG period (e.g., occasions within the CG period), and the period (e.g., a first period with four occasions (N=4, floor(CURRENT_symbol/periodicity)=floor((0, 1, 2, 3)/4)=0, 1=the occasion number index (e.g., 0, 1, 2, or 3)) includes HPI=4*0+0, HPI=4*0+1, HPI=4*0+2, HPI=4*0+3; a second period with four occasions (N=4, floor(CURRENT_symbol/periodicity)=floor((4, 5, 6, 7)/4)=1, I=the occasion number index (e.g., 0, 1, 2, or 3)) includes HPI=4*1+0, HPI=4*1+1, HPI=4*1+2, HPI=4*1+3; etc.).

In further implementations, the formula for the HARQ Process ID is defined as HPI=PUSCH_Occ_counter modulo nrofHARQ-Processes, where the PUSCH_Occ_counter is a CG-PUSCH occasion counter incremented for each CG-PUSCH occasion transmitting new data or for each configured CG-PUSCH occasion in the CG period (regardless of whether the occasion is used for transmission or skipped). In some implementations, the CG-PUSCH occasion counter is maintained for each CG configuration (with multiple CG-PUSCH occasions per CG period). In further implementations, the CG-PUSCH occasion counter is reset when the system frame number (SFN) counter is reset (e.g., at SFN=1023). Alternatively, the CG-PUSCH occasion counter is reset when PUSCH_Occ_counter modulo nrofHARQ-Processes=0.

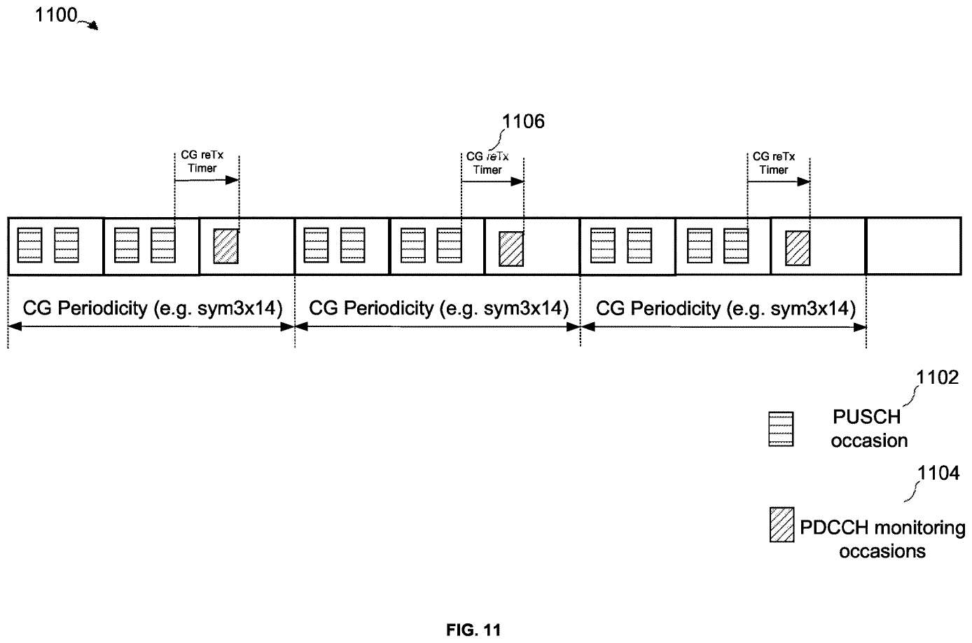

Referring next to FIG. 11, in a scenario 1100, a DCI is specifically defined for scheduling multiple PUSCH retransmissions. In some implementations, the PDCCH 1104 is configured to schedule multiple retransmissions (e.g., for the different CG-PUSCH occasions in the CG period) using a single DCI, which, in some implementations, improves spectral efficiency by using a single DCI instead of multiple DCIs, reducing the signalling overhead. In further implementations, the base station 104 instructs the UE 102 to monitor PDCCH for retransmissions after the end of the transmission of all the CG-PUSCH occasions in the CG period, reducing the UE monitoring complexity and power consumption. In some implementations, the base station 104 configures the UE 102 (e.g., via RRC) with a specifically defined configured grant timer (CGT). In some implementations, the UE 102 starts the specifically defined configured grant timer 1106 at the start of the CG-PUSCH occasion or after the transmission of the last CG-PUSCH occasion of the CG period is complete. As such, the specifically defined CGT 1106 is associated with the HARQ process, which is associated in turn with the last CG-PUSCH occasion (amongst the multiple CG-PUSCH occasions) of the CG period. If the UE 102 does not receive, from the base station 104, a dynamic scheduling from a time at which the specifically defined configured grant timer has started until a time the timer expires, the UE determines that all the CG-PUSCH occasions have been received successfully. In further implementations, the UE 102 and/or base station 104 uses an existing configured grant timer for the UL AR traffic and applies the existing CGT timer to the HARQ process associated with the last CG-PUSCH occasion (amongst the multiple CG-PUSCH occasions) of the CG period.

In some implementations, the DCI includes a bitmap to indicate the HARQ ACK/NACK feedback for the different CG-PUSCH occasions in the CG period. The values in the bitmap identified as NACKs are used for HARQ retransmissions. In further implementations, a DCI format 0_1 scrambled with CS-RNTI carries a CG-DFI (configured grant downlink feedback information) for the PUSCHs transmitted in the CG period for UL XR traffic in a licensed spectrum. In some implementations, the CG-DFI flag is configured when the UE 102 and/or base station 104 transmits XR traffic (e.g., when the UE 102 in UL transmits PDU-Sets/Data-Bursts). In some implementations, the base station 104 configures the UE 102 with the size of the HARQ-ACK bitmap in the CG-DFI flag (e.g., fixed to 16). In some implementations, the base station 104 and/or UE 102 configures the HARQ-ACK bitmap to be equal to the number of CG-PUSCH occasions in the CG period. In some implementations, if the UE 102 sends an indication to the base station 104 to cancel some CG-PUSCH occasions, the base station 104 adjusts the HARQ-ACK bitmap to the new number of CG-PUSCH occasions used by the UE 102. In some implementations, the UE 102, while monitoring the CG-DFI, determines that the HARQ-ACK bitmap size is adjusted based on the reported indication. In some implementations, the base station 104 configures the UE 102 with a PUSCH-to-HARQ-ACK timing for the UE 102 to monitor the DCI carrying the HARQ-ACK feedback. In further implementations, the PUSCH reference for the PUSCH-to-HARQ-ACK timing is the start of the first CG-PUSCH occasion, the end of the first CG-PUSCH occasion, or the end of the CG-PUSCH occasions in the CG period. In still further implementations, the CG-DFI carries HARQ-ACK feedback for multiple CG periods (e.g., multiple CG-PUSCH occasions across multiple CG periods).

In some implementations, the base station 104 sends, to the UE 102, a DCI format 0_1 scrambled with CS-RNTI to carry a HARQ-ACK bitmap for all HARQ processes transmitted in the CG period and, in some implementations, previous CG periods. In further implementations, the UE 102 sends the retransmissions in the next CG periods subject to non-expired delay budget. In some implementations, the DFI flag is one bit when cg-RetransmissionTimer is configured. The DFI flag in such implementations is set to ‘0’ when activating/releasing type 2 CG transmission and set to ‘1’ to be used as CG-DFI. The DFI flag in further implementations is reutilized for the XR traffic even when the cg-RetransmissionTimer is not configured. In some implementations, a specifically defined RRC parameter enables the DFI flag specifically for the XR traffic (e.g., when the UE 102 in UL transmits PDU-Sets/Data-Bursts).

In some implementations, the UE 102 transmits a CG-UCI on the XR CG-PUSCH occasions to signal the associated HARQ Process Identifier and set the NDI to the pre-defined value to indicate an initial transmission or a retransmission.

In some implementations, the UE 102 uses the CG-PUSCH occasions in the CG period to send HARQ retransmissions on the resources when transmitting XR traffic (e.g., when the UE 102 in UL transmits PDU-Sets/Data-Bursts). In some implementations, the CG-UCI specified for an unlicensed spectrum extends to XR traffic and is used when the UE 102 in UL transmits PDU-Sets/Data-Bursts. The UE 102 indicates in the CG-UCI that the transmission includes a retransmission by using the New Data Indictor (NDI) bit-field.

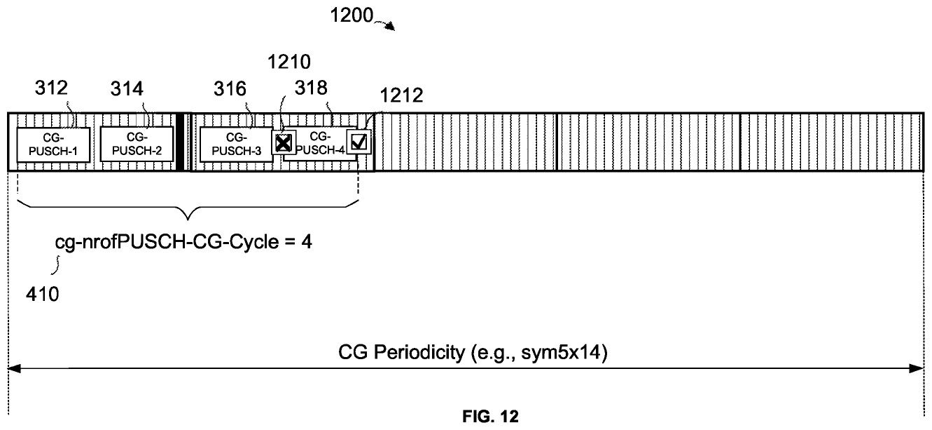

Referring next to FIG. 12, in a scenario 1200, the UE 102 in some implementations indicates to the base station 104 to cancel some CG-PUSCH occasions (e.g., using a cancellation indication 1210) because the occasions are not needed for the current available UL payload, improving the system spectral efficiency. However, in some implementations, because the base station fails to correctly receive one or multiple UL transmission, the base station 104 instructs the UE 102 to reactivate (e.g., using a reactivation indication 1212) one or multiple cancelled CG-PUSCH occasion and use the reactivated occasions for the retransmission of the failed CG-PUSCH occasions (e.g., for HARQ retransmission).

In some implementations, if the UE 102 does not or will not cancel CG-PUSCH occasions in the current CG cycle, the CG-UCI skips sending the CG-UCI or sends the CG-UCI without the cancellation indication or a cancellation bitmap.

In some implementations, the UE 102 uses a retransmission timer for the transmission of the UL AR traffic and/or PDU-Sets/Data-Bursts. In some implementations, the retransmission timer is a pre-defined timer (e.g., used in Rel-16 NR-U) and is a higher layer parameter (e.g., cg-RetransmissionTimer) configured by the base station 104 for the UE 102. In some implementations, for the UL AR traffic, a retransmission timer is specifically defined (e.g., cg-RetransmissionTimer-CG-PUSCH-Occasions) or the pre-defined retransmission timer is reused (cg-RetransmissionTimer). In some implementations, after transmitting a transport block (TB) belonging to the UL AR traffic, the UE 102 initiates a retransmission timer. In some implementations, if the UE 102 does not receive an ACK while the timer is running, the UE 102 determines a NACK scenario occurs and autonomously retransmits the same TB. In some implementations, the base station 104 sets the retransmission timer to be smaller than the delay budget. In further implementations, the mechanism reduces the latency by cutting the time required for the base station 104 to send a UL DCI to schedule the retransmission and for the UE 102 to decode the DCI. In some implementations, a specifically defined RRC parameter (e.g., cg-RetransmissionTimer-CG-PUSCH-Occasions) indicates the value of the configured retransmission timer for the CG-PUSCH occasions when multiple CG-PUSCH occasions are configured per CG period. In some implementations, in NR-U, if the UE 102 does not receive Configured Grant downlink feedback information (CG-DFI) before the parameter cgRetransmissionTimer expires, the UE 102 determines a NACK scenario occurs and carries out a retransmission autonomously in the next transmit opportunity. In some implementations, the retransmission timer extends to XR and is used when multiple CG-PUSCH occasions are configured per CG period. In some implementations, the retransmission timer is a single value applied to all CG-PUSCH occasions in the CG period, or the retransmission timer is multiple fields with a retransmission timer for each CG-PUSCH occasion. For example, a base station 104 and/or UE 102 allocate some retransmission timers to initial CG-PUSCH occasions and smaller retransmission timers to subsequent CG-PUSCH occasions. In some implementations, if the UE 102 does not receive grant free downlink feedback information (GF-DFI) from the base station 104 before the timer expires for a specific CG-PUSCH occasion, the UE 102 determines a NACK scenario occurs and retransmits autonomously for the specific CG-PUSCH occasion. In further implementations, a single retransmission timer is specifically defined for the group of CG-PUSCH occasions belonging to the same CG period. In some implementations, the single retransmission timer is a single value applied separately to all CG-PUSCH occasions in the CG period (i.e., the timer is started for each CG-PUSCH occasion separately). In further implementations, the timer is a single value applied to the group of CG-PUSCH occasions in the CG period (i.e., the timer starts at the end of the last OFDM symbol of the last CG-PUSCH occasion in the CG period).

In some implementations, the base station 104 configures the UE 102 to use the existing timer (e.g., RRC parameter configuredGrantTimer) for each CG-PUSCH occasion in the CG period (e.g., instead of the cg-RetransmissionTimer used for Rel-16 NR-U CG-PUSCH occasions). The timer starts at the first symbol of each PUSCH transmission occasion (or at the last symbol of each PUSCH transmission occasion), and the UE 102 monitors PDCCH for any retransmission and determines a positive acknowledgment if the timer expires. In further implementations, the existing timer (e.g., RRC parameter configuredGrantTimer) applies for the first time to the last PUSCH transmission occasion in the CG period. In further implementations, the existing timer (e.g., RRC parameter configuredGrantTimer) or a specifically defined timer applies to some of the CG-PUSCH occasions and applies to the CG-PUSCH occasions and some previous CG-PUSCH occasions. For example, where 20 CG-PUSCH occasions are in the CG period, the existing timer (e.g., RRC parameter configuredGrantTimer) or a specifically defined timer applies at CG-PUSCH occasion number 5 and covers CG-PUSCH occasions 1 to 5, and then applies at CG-PUSCH occasion number 10 and covers CG-PUSCH occasions 6 to 10, etc.

In some implementations, the base station 104 signals, to the UE 102, a configured grant timer for each CG-PUSCH occasion in the CG period. In some implementations, a specifically defined RRC parameter (e.g., timeDomainOffset-CG-PUSCH-Occasions) indicates the configured grant timer for the CG-PUSCH occasions. The field indicates the time duration that a UE 102 waits for a retransmission request from the base station 104 after transmitting one or multiple CG-PUSCH occasions. The UE 102 determines a positive acknowledgment if the timer expires. Depending on the implementation, different timers are configured for each CG-PUSCH occasion, and the timers start separately at the end of each CG-PUSCH occasion. In further implementations, the specifically defined RRC parameter is a single timer applied to a group of CG-PUSCH occasions in the CG period. Depending on the implementation, the timer starts at the end or at the start of the last CG-PUSCH occasion in the CG period.

In some implementations, the base station 104 updates the parameters described above (e.g., with regard to FIGS. 4-12) via semi-static signalling (e.g., RRC re-configuration) or via dynamic signalling (e.g., DCI). For example, the base station 104 collects statistics about the number of used CG-PUSCH occasions per CG period and readjusts the configuration based on the collected statistics. For example, the base station 104 initially configures the UE 102 with 5 CG-PUSCH occasions per CG period. In some implementations, the base station 104 observes (e.g., after some time and/or after collecting enough statistics) that the UE 102 generally uses 3 CG-PUSCH occasions for the UL traffic instead of the initially configured 5 CG-PUSCH occasions. In some implementations, the base station 104 readjusts the configuration. The adjustment reduces the UE UL cancellation signalling overhead sent by the UE 102 to the base station 104.

In some implementations, the UE 102 monitors a specifically defined or pre-defined DCI format to be sent by the base station 104 that carries an update to the CG configuration. For example, the DCI updates the number of CG-PUSCH occasions in the CG period by increasing or reducing the number of CG-PUSCH occasions.

In some implementations, when multiple PUSCH transmission occasions per CG period are enabled, the UE 102 and/or base station 104 calculates the HARQ process identifier for each CG-PUSCH occasion using the following expression: HPI=[floor(CURRENT_symbol/periodicity)]modulo nrofHARQ-Processes, where CURRENT_symbol=(SFN×SlotsPerFrame×SymbolsPerSlot)+(SlotNumber×SymbolsPerSlot)+SymbolNumber, where SymbolsPerSlot is 14 for normal CP and 12 for ECP. The SFN is the system frame number. SlotNumber is the slot number within which the CG-PUSCH occasion in the CG period starts. The SymbolNumber is the symbol number at which the CG-PUSCH occasion in the CG period starts.

In some implementations, the Multiple PUSCH transmission occasions in the CG period are associated with the same HARQ Process Identifier.

If the multiple PUSCH transmission occasions in the CG period are associated with the same HARQ Process Identifier, the UE 102 and/or base station 104 calculates the HARQ process identifier for all the CG-PUSCH occasions using the following expression: HPI=[floor(CURRENT_symbol/periodicity)]modulo nrofHARQ-Processes, where CURRENT_symbol=(SFN×SlotsPerFrame×SymbolsPerSlot)+(SlotNumber×SymbolsPerSlot)+SymbolNumber, where SymbolsPerSlot is 14 for normal CP and 12 for ECP. The SFN is the system frame number. SlotNumber is the slot number within which the CG-PUSCH occasion in the CG period starts. The SymbolNumber is the symbol number at which the CG-PUSCH occasion in the CG period starts. In some implementations, for retransmissions, the base station 104 indicates, to the UE 102, in the retransmission scheduling DCI, the HARQ Process Identifier and the index or the indices of the CG-PUSCH occasions to be retransmitted.

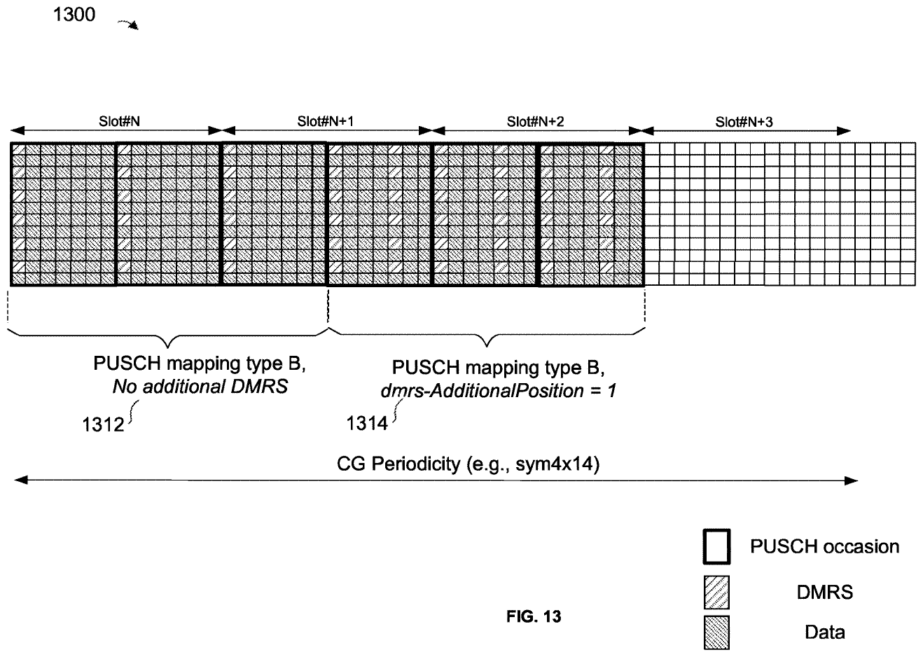

Referring next to FIG. 13, in a scenario 1300, the base station 104 in some implementations configures the UE 102 with a dedicated demodulation reference signal (DMRS) configuration to be applied to all CG-PUSCH occasions in the CG period. For example, the DMRS-UplinkConfig information element (e.g., defined in Error! Use the Home tab to apply ZA to the text that you want to appear here. is applied to all the CG-PUSCH occasions in the CG period. In further implementations, different CG-PUSCH occasions in the CG period have different DMRS configurations and/or different PUSCH mapping types. For example, as shown in FIG. 13, if 6 CG-PUSCH occasions are configured per CG period, the first 3 CG-PUSCH occasions 1312 are not configured with additional DMRS and the remaining 3 CG-PUSCH occasions 1314 in the CG period include additional DMRS. The earliest CG-PUSCH occasions have more delay budget and can benefit from more retransmissions, the latest CG-PUSCH occasions, however, have less delay budget and, as such, fewer opportunities for retransmissions. As such, additional UL DMRS symbols improve reliability for such occasions. In further implementations, the UE 102 sends some CG-PUSCH occasions without DMRS to reduce the UL signalling overhead, and the base station 104 uses DMRS from other CG-PUSCH occasions for channel estimation. In further implementations, the UE 102 has the flexibility to select the DMRS configuration suitable for each CG-PUSCH transmission and signal to the base station 104 the selected DMRS configuration in the CG-UCI.

In some implementations, the multiple CG-PUSCH occasions in the CG period support the CBG-based retransmissions, saving resources and improving spectral efficiency. In some implementations, for CBG-based transmission, instead of acknowledging one TB with a single HARQ-ACK bit, multiple HARQ-ACK bits acknowledge multiple segments of a TB. The use of CBG-based retransmissions improves spectral efficiency for large packets like UL AR traffic. In some implementations, DCI format 0_1 scrambled with CS-RNTI carries a CG-DFI for all CBGs in one or multiple of the CG-PUSCH occasions transmitted in the CG period for UL XR traffic in a licensed spectrum, where the HARQ-ACK bitmap is configured to be equal to the number of CG-PUSCH occasions in the CG period multiplied by the number of CBGs per CG-PUSCH occasion.

In some implementations, if the UE 102 has a PUCCH to be transmitted to the base station 104, and the PUCCH overlaps with a CG-PUSCH occasion in the CG period, the UE 102 multiplexes the PUCCH with the CG-PUSCH occasion (e.g., the CG-PUSCH occasion is associated with UL AR traffic or with PDU-Sets/Data-Bursts). In further implementations, if the PUCCH is associated with low priority traffic (e.g., eMBB traffic), then the UE 102 and/or the base station 104 drops or postpones the PUCCH, and the CG-PUSCH occasion has priority.

In some implementations, if the UE 102 has an SR, an SRS, or any another PUSCH to be transmitted to the base station 104 and the SR, the SRS, or the other PUSCH overlaps with a CG-PUSCH occasion in the CG period, the UE 102 multiplexes the SR, the SRS, or the other PUSCH with the CG-PUSCH occasion. In further implementations, if the SR, the SRS, or the other PUSCH is associated with low priority traffic (e.g., eMBB traffic), then the UE 102 and/or base station 104 drops or postpones the PUCCH, and the CG-PUSCH occasion (e.g., associated with the UL AR traffic) has priority.

In some implementations, Grant-based PUSCH has higher priority over Configured Grant PUSCH, and, if a UL DCI schedules Grant-based PUSCH and the Grant-based resources overlap with the Configured Grant resources, then Grant-based PUSCH has priority over configured grant. In some implementations, for UL XR traffic (e.g., UL AR traffic, UL Pose/Control information traffic, PDU-Sets/Data-Bursts, etc.) the Configured Grant PUSCH associated with the XR traffic has priority over the Grant-based PUSCH associated with other types of traffic (e.g., EMBB traffic). In some implementations, the base station 104 determines that the UE 102 does not have UL XR data to transmit, and, in some implementations, schedules PUSCH transmissions for other UL data (e.g., eMBB traffic to which the base station 104 has previously received an SR from the UE 102). However, if the UE 102 has UL XR traffic to be transmitted, the UE 102 in some implementations prioritizes the configured grant transmission when transmitting the data includes using the configured grant to transmit UL XR data.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, the “LTM command” can be replaced by “serving cell change command”, “Layer 1/Layer 2 switching command”, “lower layer switching command” or “lower layer serving cell change command”. In some implementations, “some” means “one or more”. In some implementations, “at least one” means “one or more”. In some implementations, the “DU configuration” can be replaced by “cell group configuration”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method implemented in a user equipment (UE), the method comprising:
transmitting, to a radio access network (RAN) node, an uplink transmission using one or more configured grant (CG) resources;
receiving, from the RAN node, downlink control information including a request process identifier based on a number of CG uplink channel occasions in a CG period such that the request process identifier is determined using the number of CG uplink channel occasions in the CG period multiplied by an output of a floor function, the floor function calculated using a symbol index for a respective CG uplink channel occasion and a periodicity of the CG period; and
retransmitting, to the RAN node, a transmission of the uplink transmission based on the request process identifier.

2. The method of claim 1, further comprising:
determining the request process identifier based on an offset value such that the request process identifier scales additively and positively with the offset value.

3. The method of claim 2, wherein:
the offset value is an index value associated with a CG uplink channel occasion of the CG uplink channel occasions in the CG period.

4. The method of claim 3, wherein:
the determining the request process identifier includes determining the request process identifier according to hybrid automatic repeat request (HARQ) Process ID=[N*floor(CURRENT_symbol/periodicity)+I]modulo nrofHARQ-Processes, where HARQ Process ID is the request process identifier, N is the number of CG uplink channel occasions in the CG period, periodicity is the periodicity of the CG period, CURRENT_symbol is the symbol index for the respective CG uplink channel occasion, I is the index value, and nrofHARQ-Processes is a quantity of request processes.

5. The method of claim 4, wherein:
the index value has a range from 0 to N−1.

6. The method of claim 4, wherein:
the index value is 0 for an initial CG uplink channel occasion within the periodicity of the CG period; and
the index value is N−1 for a last CG uplink channel occasion within the periodicity of the CG period.

7. The method of claim 1, wherein:
the request process identifier is a hybrid automatic repeat request (HARQ) process identifier.

8. (canceled)

9. A method implemented in a radio access network (RAN) node, the method comprising:
communicating with a user equipment (UE) using one or more configured grant (CG) resources;
determining a request process identifier based on a number of CG uplink channel occasions in a CG period such that the request process identifier is determined using the number of CG uplink channel occasions in the CG period multiplied by an output of a floor function, the floor function calculated using a symbol index for a respective CG uplink channel occasion and a periodicity of the CG period; and
transmitting, to the UE, a request for retransmission of a failed transmission, the request including the request process identifier.

10. The method of claim 9, wherein:
the determining the request process identifier is further based on an offset value such that the request process identifier scales additively and positively with the offset value.

11. The method of claim 10, wherein:
the offset value is an index value associated with a CG uplink channel occasion of the CG uplink channel occasions in the CG period.

12. The method of claim 11, wherein:
the determining the request process identifier includes determining the request process identifier according to hybrid automatic repeat request (HARQ) Process ID=[N*floor(CURRENT_symbol/periodicity)+I]modulo nrofHARQ-Processes, where HARQ Process ID is the request process identifier, N is the number of CG uplink channel occasions in the CG period, periodicity is the periodicity of the CG period, CURRENT_symbol is the symbol index for the respective CG uplink channel occasion, I is the index value, and nrofHARQ-Processes is a quantity of request processes.

13. The method of claim 12, wherein:
the index value has a range from 0 to N−1.

14. The method of claim 12, wherein:
the index value is 0 for an initial CG uplink channel occasion within the periodicity of the CG period; and
the index value is N−1 for a last CG uplink channel occasion within the periodicity of the CG period.

15. (canceled)

16. An apparatus, operating as a user equipment (UE), comprising:
processing hardware configured to:
transmit, to a radio access network (RAN) node, an uplink transmission using one or more configured grant (CG) resources;
receive, from the RAN node, downlink control information including a request process identifier based on a number of CG uplink channel occasions in a CG period such that the request process identifier is determined using the number of CG uplink channel occasions in the CG period multiplied by an output of a floor function, the floor function calculated using a symbol index for a respective CG uplink channel occasion and a periodicity of the CG period; and
retransmit, to the RAN node, a transmission of the uplink transmission based on the request process identifier.

17. The apparatus of claim 16, wherein the processing hardware is further configured to:
determine the request process identifier based on an offset value such that the request process identifier scales additively and positively with the offset value.

18. The apparatus of claim 17, wherein:
the offset value is an index value associated with a CG uplink channel occasion of the CG uplink channel occasions in the CG period.

19. The apparatus of claim 18, wherein the processing hardware configured to determine the request process identifier is further configured to:
determine the request process identifier according to hybrid automatic repeat request (HARQ) Process ID=[N*floor(CURRENT_symbol/periodicity)+I]modulo nrofHARQ-Processes, where HARQ Process ID is the request process identifier, N is the number of CG uplink channel occasions in the CG period, periodicity is the periodicity of the CG period, CURRENT_symbol is the symbol index for the respective CG uplink channel occasion, I is the index value, and nrofHARQ-Processes is a quantity of request processes.

20. The apparatus of claim 19, wherein:
the index value has a range from 0 to N−1.

21. The apparatus of claim 19, wherein:
the index value is 0 for an initial CG uplink channel occasion within the periodicity of the CG period; and
the index value is N−1 for a last CG uplink channel occasion within the periodicity of the CG period.

22. The apparatus of claim 16, wherein:
the request process identifier is a hybrid automatic repeat request (HARQ) process identifier.
